(19) United States
(12) Patent Application Publication
(10) Pub. No.: US 2014/0195192 A1
(43) Pub. Date: Jul. 10, 2014

(54) INFORMATION PROCESSING APPARATUS, INFORMATION PROCESSING METHOD, PROGRAM, AND RECORDING MEDIUM

(71) Applicant: Masato Kimishima, Tokyo (JP)

(72) Inventor: Masato Kimishima, Tokyo (JP)

(73) Assignee: SONY CORPORATION, Tokyo (JP)

(21) Appl. No.: 14/239,716

(22) PCT Filed: Aug. 22, 2012
(86) PCT No.: PCT/JP2012/005262

§ 371 Date: Feb. 19, 2014

(30) Foreign Application Priority Data
Aug. 30, 2011 (JP) 2011-186710

(51) Int. Cl. G01C 23/00; G01P 3/64

(52) U.S. Cl. CPC G01C 23/00; G01P 3/64
USPC 702/149

(57) ABSTRACT

The information processing apparatus includes an absolute position acquiring unit that acquires an absolute position of a user, an acquiring unit that acquires first values according to physical movement of the user who walks, a function specifying unit that assumes a function showing a relation between the first values and second values showing a pace or a walking speed of the user, calculates coefficients included in the function based on the first values and the absolute position, and specifies the function, a calculating unit that calculates the second values corresponding to the first values using the function, and a learning unit that learns a correspondence relation between a walking tempo of the user and the second values using the calculated second values.

### TECHNICAL FIELD

The present disclosure relates to an information processing apparatus, an information processing method, a program, and a recording medium.

### BACKGROUND ART

Recently, systems using position information have spread widely. As a method of acquiring position information, autonomous navigation is known. Autonomous navigation is used mainly when absolute positioning such as GPS positioning cannot be used. Autonomous navigation is a method by which a relative position is calculated from a final positioning spot by absolute positioning using a movement speed and a movement direction and current position information is acquired.

As a method of obtaining a speed in autonomous navigation while walking, a method using a pedometer may be used. At this time, the speed can be acquired using the following expression 1.

v=k′f (1)

In this case, v shows a movement speed, k shows a pace of a user, and f shows a walking tempo (the number of steps per unit time). The walking tempo f that is used in the expression is calculated by dividing the number of steps acquired by the pedometer using an acceleration sensor by time. Because the pace k is different for each user, the pace is learned in advance.

As a simplest method of learning the pace k, a method of calculating the pace by dividing a movement distance obtained by the GPS positioning by the number of steps during movement may be used. In this case, if a value of an average pace is used uniformly, an error may increase in a situation in which the user moves at various paces.

Patent Document 1 discloses a method of performing GPS positioning every predetermined time, dividing the movement distance for the predetermined time by the number of steps, and calculating the pace. At this time, a correspondence table in which a calculated average pace and an average walking tempo for the corresponding time are associated with each other is made. If the correspondence table is used, a pace according to a walking tempo value that is obtained from the pedometer can be used when the speed is calculated.

### CITATION LIST

### Patent Literature

PTL 1: Patent Document 1: Japanese Patent Application Laid-Open No. 2010-85285

### SUMMARY

### Technical Problem

However, in the correspondence table that is made using the average pace and the average walking tempo in the predetermined time, a range of the walking tempo may be narrowed more than an actual range. For this reason, when the user walks at a speed different from an ordinary speed, a correct pace cannot be obtained. Therefore, there has been a demand to improve precision of the correspondence table used for autonomous navigation.

### Solution to Problem

According to the present disclosure, there is provided an information processing apparatus including an absolute position acquiring unit that acquires an absolute position of a user, an acquiring unit that acquires first values according to physical movement of the user who walks, a function specifying unit that assumes a function showing a relation between the first values and second values showing a pace or a walking speed of the user, calculates coefficients included in the function based on the first values and the absolute position, and specifies the function, a calculating unit that calculates the second values corresponding to the first values using the function, and a learning unit that learns a correspondence relation between a walking tempo of the user and the second values using the calculated second values.

According to this configuration, the function realized between the first value and the second value is assumed and the correspondence relation is calculated using the second value calculated using the function specified based on the obtained first value. Therefore, even when the walking tempo changes in a section, the movement speed can be calculated for each walking tempo. For this reason, a range of a walking tempo in a correspondence table can be approximated to a range of an actual walking tempo. Therefore, a correspondence table of a wide range is made and precision of the correspondence table is improved.

According to the present disclosure, there is provided an information processing method including the steps of acquiring an absolute position of a user, acquiring first values according to physical movement of the user who walks, assuming a function showing a relation between the first values and second values showing a pace or a walking speed of the user, calculating coefficients included in the function based on the first values and the absolute position, and specifying the function, calculating the second values corresponding to the first values using the function, and learning a correspondence relation between a walking tempo of the user and the second values using the calculated second values.

According to the present disclosure, there is provided a program for causing a computer to function as an information processing apparatus including an absolute position acquiring unit that acquires an absolute position of a user, an acquiring unit that acquires first values according to physical movement of the user who walks, a function specifying unit that assumes a function showing a relation between the first values and second values showing a pace or a walking speed of the user, calculates coefficients included in the function based on the first values and the absolute position, and specifies the function, a calculating unit that calculates the second values corresponding to the first values using the function, and a learning unit that learns a correspondence relation between a walking tempo of the user and the second values using the calculated second values.

According to the present disclosure, there is provided a computer readable recording medium that stores a program for causing a computer to function as an information processing apparatus including an absolute position acquiring unit that acquires an absolute position of a user, an acquiring unit that acquires first values according to physical movement of the user who walks, a function specifying unit that assumes a function showing a relation between the first values and second values showing a pace or a walking speed of the user, calculates coefficients included in the function based on the first values and the absolute position, and specifies the function, a calculating unit that calculates the second values corresponding to the first values using the function, and a learning unit that learns a correspondence relation between a walking tempo of the user and the second values using the calculated second values.

### Advantageous Effects of Invention

According to the present disclosure, precision of a correspondence table used for autonomous navigation while walking is improved.

### BRIEF DESCRIPTION OF DRAWINGS

FIG. 1 is a block diagram illustrating a functional configuration of a portable terminal according to a first embodiment of the present disclosure.

FIG. 2 is a block diagram illustrating a hardware configuration of the portable terminal according to the first embodiment of the present disclosure.

FIG. 3 is a flowchart of an example of an operation of the portable terminal according to the first embodiment of the present disclosure.

FIG. 4 is a flowchart of an example of an operation of distance threshold value determination processing of the portable terminal according to the same embodiment.

FIG. 5 is a flowchart of another example of the operation of the distance threshold value determination processing of the portable terminal according to the same embodiment.

FIG. 6 is a flowchart of an example of an autonomous positioning operation of the portable terminal according to the same embodiment.

FIG. 7 is a block diagram illustrating a functional configuration of a portable terminal according to a second embodiment of the present disclosure.

FIG. 8 is an explanatory diagram for explaining an outline of a function of the portable terminal according to the same embodiment.

FIG. 9 is an explanatory diagram for explaining the case in which a function can be specified in making a correspondence table of the portable terminal according to the same embodiment.

FIG. 10 is an explanatory diagram for explaining the case in which a function cannot be specified in making a correspondence table of the portable terminal according to the same embodiment.

FIG. 11 is a flowchart of an example of an operation of the portable terminal according to the same embodiment.

FIG. 12 is a flowchart of an example of an operation of input value integration processing of the portable terminal according to the same embodiment.

FIG. 13 is a flowchart of an example of an operation of coefficient calculation processing of the portable terminal according to the same embodiment.

FIG. 14 is a flowchart of an example of an operation of walking tempo classification processing of the portable terminal according to the same embodiment.

FIG. 15 is an explanatory diagram for explaining the walking tempo classification processing of the portable terminal according to the same embodiment.

FIG. 16 is an explanatory diagram for explaining a specific example of the walking tempo classification processing of the portable terminal according to the same embodiment.

FIG. 17 is a block diagram illustrating a functional configuration of a portable terminal according to a third embodiment of the present disclosure.

FIG. 18 is an explanatory diagram for explaining the case in which a function can be specified in making a correspondence table of the portable terminal according to the same embodiment.

FIG. 19 is an explanatory diagram for explaining the case in which a function cannot be specified in making a correspondence table of the portable terminal according to the same embodiment.

FIG. 20 is a flowchart of an example of an operation of the portable terminal according to the same embodiment.

FIG. 21 is a graph of an example of an experimental result showing a change of a walking tempo in the portable terminal according to the same embodiment.

FIG. 22 is a graph of an example of an experimental result comparing a speed estimated in the portable terminal according to the same embodiment and an actual speed.

FIG. 23 is an explanatory diagram illustrating an example of a correspondence table of a walking tempo and a speed that is made in the portable terminal according to the same embodiment.

FIG. 24 is an explanatory diagram illustrating an example of a correspondence table of a walking tempo and a pace that is made in the portable terminal according to the same embodiment.

FIG. 25 is a graph of the case in which vertical acceleration measured in the portable terminal according to the same embodiment is correlated with an actual speed.

FIG. 26 is a graph of an experimental result of vertical acceleration that was measured in a state in which the portable terminal according to the same embodiment was put into a front pants pocket.

FIG. 27 is a graph of the case in which a peak value for every two seconds is extracted from the experimental result of FIG. 26.

FIG. 28 is a graph of an experimental result comparing an estimated speed of each section calculated using the function specified in the portable terminal according to the same embodiment and an actual speed.

FIG. 29 is an explanatory diagram illustrating an example of a correspondence table that is made using the function specified in the portable terminal according to the same embodiment.

FIG. 30 is a graph of an experimental result comparing an estimated speed for each section calculated using a function specified by vertical acceleration measured in a state in which the portable terminal according to the same embodiment was put into a breast pocket and an actual speed.

FIG. 31 is a graph of an experimental result comparing an estimated speed for each section calculated using a function specified by vertical acceleration measured in a state in which the portable terminal according to the same embodiment was put into a stomach pocket and an actual speed.

FIG. 32 is a graph of an experimental result comparing an estimated speed for each section calculated using a function specified by vertical acceleration measured in a state in which the portable terminal according to the same embodiment was put into a back pants pocket and an actual speed.

FIG. 33 is a graph of an experimental result comparing an estimated speed for each section calculated using a function specified by vertical acceleration measured in a state in which the portable terminal according to the same embodiment was put into an oblique bag and an actual speed.

FIG. 34 is an explanatory diagram illustrating an example of a correspondence table of a walking tempo and a pace.

FIG. 35 is an explanatory diagram for explaining the case in which a pace is learned using an absolute position acquired in a predetermined time.

FIG. 36 is an explanatory diagram illustrating an example of a correspondence table made when a pace is learned using an absolute position acquired in a predetermined time.

FIG. 37 is an explanatory diagram illustrating an example of a correspondence table made using an average of paces and an average of walking tempos.

### DESCRIPTION OF EMBODIMENTS

Hereinafter, preferred embodiments of the present disclosure will be described in detail with reference to the appended drawings. Note that, in this specification and the drawings, elements that have substantially the same function and structure are denoted with the same reference signs, and explanation thereof is not repeated.

The following description will be made in the order described below.

1. Outline

2. First Embodiment (example using absolute position acquired for every predetermined distance)

2-1. Functional Configuration

2-2. Example of Hardware Configuration

2-3. Example of Operation

2-4. Determination of Distance Threshold Value

2-5. Autonomous Positioning

2-6. Example of Effect

3. Second Embodiment (example using function specified on the assumption that movement speed and walking tempo are correlated with each other)

3-1. Functional Configuration

3-2. Example of Operation

3-3. Classification of Walking Tempo

3-34. Example of Effect

4. Third Embodiment (example of the case having configurations of first and second embodiments)

4-1. Functional Configuration

4-2. Example of Operation

4-3. Experimental Result

4-4. Input Value

4-5. Method of Carrying Portable Terminal

### 1. Outline

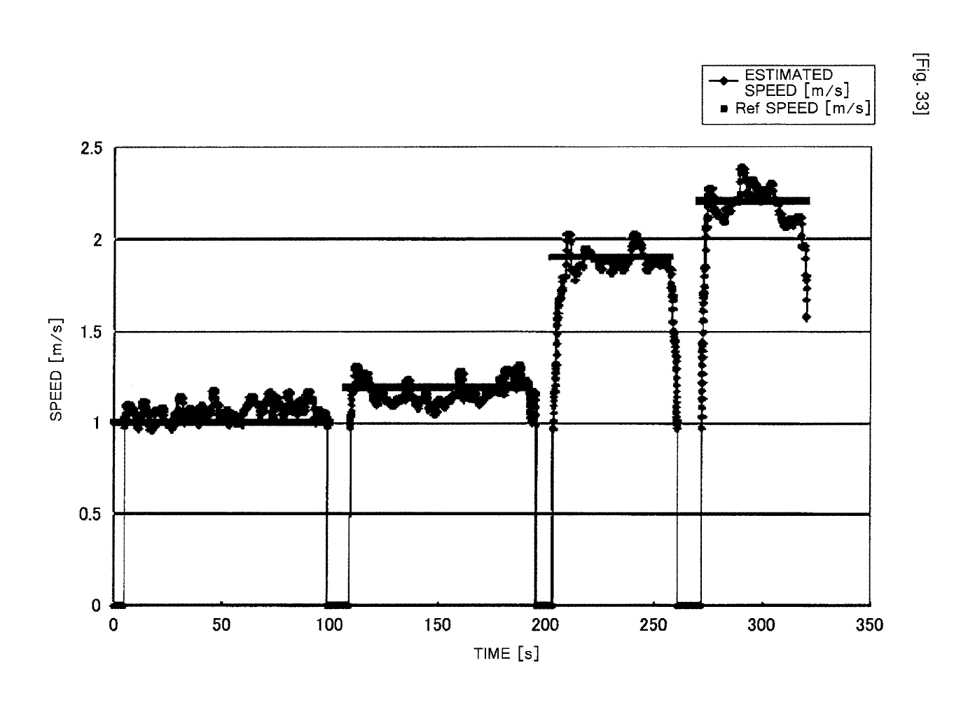

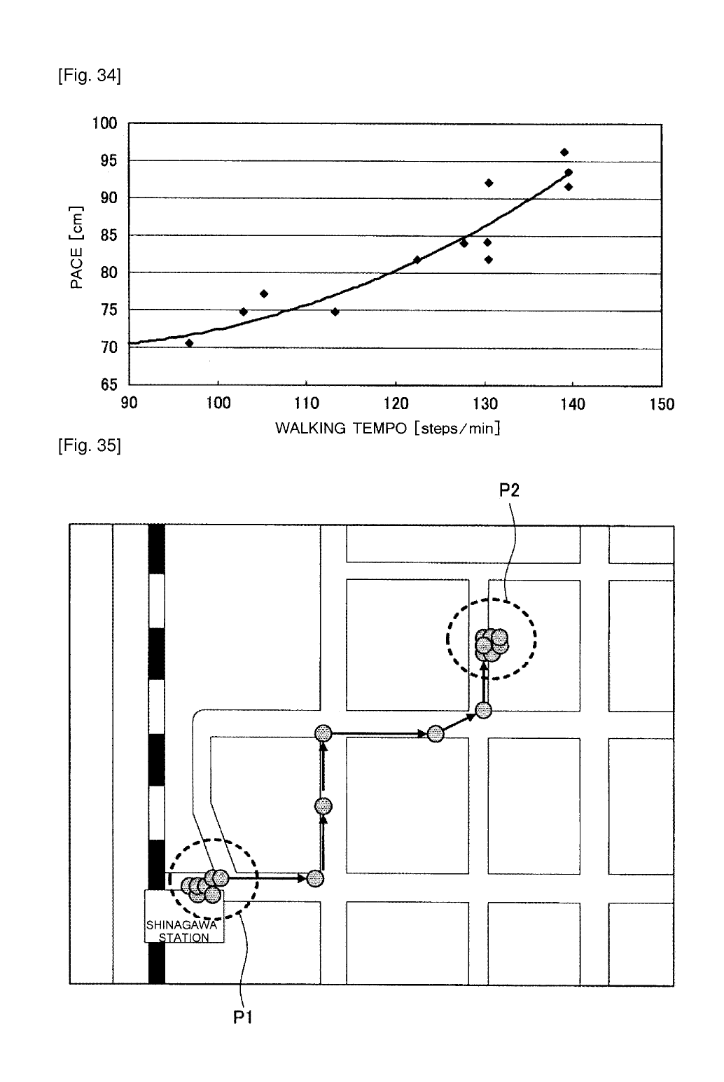

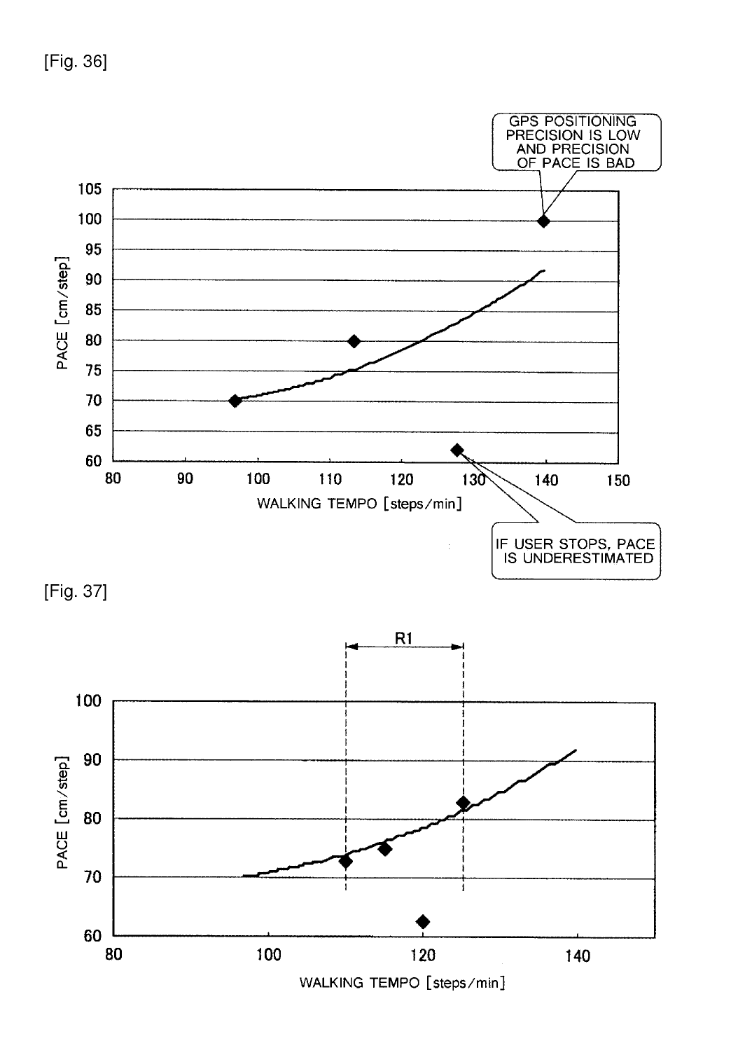

First, an outline of the present disclosure will be described with reference to FIGS. 34 to 37. FIG. 34 is an explanatory diagram illustrating an example of a correspondence table of a walking tempo and a pace. FIG. 35 is an explanatory diagram for explaining the case in which a pace is learned using an absolute position acquired in a predetermined time. FIG. 36 is an explanatory diagram illustrating an example of a correspondence table made when a pace is learned using an absolute position acquired in a predetermined time. FIG. 37 is an explanatory diagram illustrating an example of a correspondence table made using an average of paces and an average of walking tempos.

For example, in an information processing apparatus such as a navigation apparatus, a terminal apparatus that has a function of acquiring position information has been spread. As methods for acquiring the position information in the information processing apparatus, absolute positioning using a positioning satellite such as a GPS, absolute positioning of estimating the distance with each base station from reception strength of a Wifi electric wave transmitted from a Wifi base station and calculates a current position, and autonomous navigation may be used.

Autonomous navigation is a method of calculating a relative position from a positioning spot of a previous absolute position using information acquired by a sensor and acquiring current position information. Autonomous navigation may be used when the absolute position cannot be acquired. Autonomous navigation may be used to correct an error of the absolute position.

For example, in a place such as a tunnel in which the sky is covered, a GPS signal may not be received and the current position may not be acquired using GPS positioning. At this time, if the relative position from the absolute position acquired immediately before the tunnel is calculated from information acquired by the sensor, the current position information can be acquired in a place at which the GPS signal cannot be received.

In this case, the relative position is calculated using a movement speed and a movement direction. The movement direction can be acquired using a function of an electronic compass using a geomagnetic sensor. In particular, as a method of acquiring a speed through autonomous navigation at the time of walking, a method using a pedometer may be used. At this time, the speed can be acquired using a relation of the following expression 1 that is realized using a pace k and a walking tempo f of a user.

v=k′f (1)

In this case, the walking tempo f shows the number of steps per unit time. For example, the walking tempo f is calculated by dividing the number of steps acquired by the pedometer using an acceleration sensor by time. Because the pace k is different for each user, the pace is learned in advance.

As a simplest method of learning the pace k, a method of calculating the pace by dividing the movement distance obtained by the GPS positioning by the number of steps during movement may be used. In this case, a value of the pace k is different for each user and is different according to the walking tempo of each user.

As illustrated in FIG. 34, the speed can be calculated using the pace according to the value of the walking tempo obtained by the pedometer, by learning the value of the pace according to the walking tempo. For this reason, precision of the calculated speed is improved as compared with the case in which the same average pace is used uniformly without depending on the walking tempo.

In the present disclosure, technology for improving precision of the calculated movement speed in the information processing apparatus that calculates the movement speed using a correspondence table of the walking tempo and the pace is suggested. As a first aspect, technology for using the predetermined distance as a trigger to acquire the movement distance used to calculate the pace is suggested. For example, in FIG. 35, current positions of the user that are acquired at a predetermined time interval are shown by circles on a map. In periods P1 and P2 at which the user stops or moves in a predetermined range, the movement distance in a predetermined time is short. Meanwhile, in a period between the periods P1 and P2, the movement distance in the predetermined time is long. An error of the movement distance acquired by the absolute positioning relatively decreases when the actual distance increases. For example, an error of the GPS positioning is about 10 m to 100 m. When the movement distance is acquired at the predetermined time interval, the movement distance in the period may not be equal to or more than the distance that enables sufficient precision. For this reason, as illustrated in FIG. 36, precision of the absolute position is low and precision of the pace may become low. When the user stops, the pace may be underestimated. Therefore, in a first embodiment of the present disclosure to be described below, technology for using the predetermined distance as a trigger to acquire the movement distance, instead of the predetermined time, is suggested.

As a second aspect, technology for assuming a function realized between a first value (for example, walking tempo) according to physical movement of the walking user and a second value (pace or movement speed of the user), specifying the function from a value acquired by the sensor, and making a correspondence table is suggested. FIG. 37 illustrates an example of a correspondence table when an average pace corresponding to an average walking tempo is calculated. As such, a range R1 of the average walking tempo that is acquired in a situation in which the movement speed changes is narrower than an actual range. For this reason, when the user moves at a speed different from an ordinary speed, precision of the calculated speed may be lowered. Therefore, in a second embodiment of the present disclosure to be described below, technology for assuming the function realized between the first value and the second value and acquiring a pace or a movement speed having high precision with respect to each walking tempo, instead of an average value of the predetermined time, is suggested.

In a third embodiment of the present disclosure, an embodiment that has the configurations of the first and second aspects will be described.

### 2. First Embodiment

### 2-1. Functional Configuration

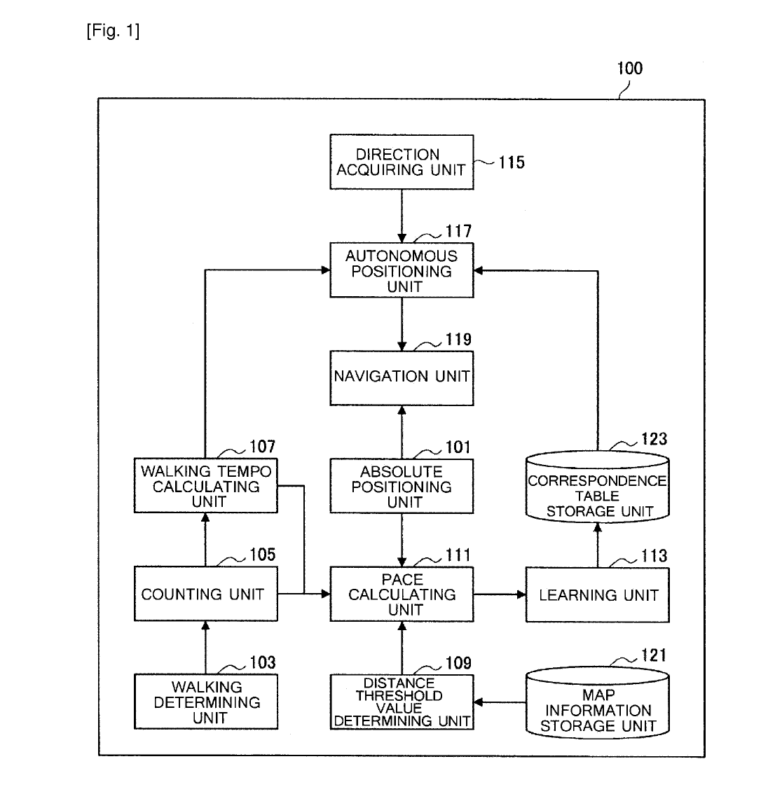

In this case, a functional configuration of a portable terminal according to the first embodiment of the present disclosure will be described with reference to FIG. 1. FIG. 1 is a block diagram illustrating the functional configuration of the portable terminal according to the first embodiment of the present disclosure.

A portable terminal 100 is an information processing apparatus that has an autonomous navigation function during walking. The portable terminal 100 may be an information processing apparatus such as a mobile phone, a personal digital assistant (PDA), a smart phone, a portable music reproducing apparatus, a portable video processing apparatus, a portable game machine, a portable personal computer (PC) (including a notebook PC and a tablet type PC), and a navigation apparatus including a personal navigation device (PND). In the following description of this embodiment, the user who carries the portable terminal 100 is simply referred to as the user.

The portable terminal 100 mainly includes an absolute positioning unit 101, a walking determining unit 103, a counting unit 105, a walking tempo calculating unit 107, a distance threshold value determining unit 109, a pace calculating unit 111, a learning unit 113, a direction acquiring unit 115, an autonomous positioning unit 117, a navigation unit 119, a map information storage unit 121, and a correspondence table storage unit 123.

(Absolute Positioning Unit 101)

The absolute positioning unit 101 has a function of acquiring the absolute position of the user. The absolute positioning unit 101 may be a GPS antenna and a GPS processing unit that processes a GPS signal received by the GPS antenna. Alternatively, the absolute positioning unit 101 may be a Wifi antenna that receives Wifi electric waves from a plurality of base stations and a position calculating unit that estimates the distance with each base station from the reception strength of the received Wifi electric waves and calculates a current position based on a principle of triangulation using the distance with each base station and the position of each base station.

(Walking Determining Unit 103)

The walking determining unit 103 has a function of determining whether the user is walking. The walking determining unit 103 can use a sensor such as an acceleration sensor that detects motion. In this case, although the term “walking” is used, the walking determining unit 103 can determine that the user is walking, even when the user is running.

(Counting Unit 105)

The counting unit 105 has a function of counting the number of steps and a movement time relating to movement of the user. When the walking determining unit 103 determines that the user is walking, the counting unit 105 can count the number of steps and the movement time. The counting unit 105 may count the movement time only when it is determined that the user is walking and may not include a period in which the user is stopped in the movement time.

(Walking Tempo Calculating Unit 107)

The walking tempo calculating unit 107 has a function of calculating the walking tempo of the user using the number of steps and the movement time counted by the counting unit 105. The walking tempo calculating unit 107 can convert the counted number of steps into the number of steps per unit time and calculate the walking tempo. At this time, the movement time that is counted by the counting unit 105 does not include the period in which the user is stopped, as described above. For this reason, the walking tempo calculating unit 107 can calculate the walking tempo with higher precision. In this case, the calculated walking tempo is an example of the first value according to the physical movement of the user. However, the first value is not limited to the above example. For example, the first value may be another value that is correlated with the speed.

(Distance Threshold Value Determining Unit 109)

The distance threshold value determining unit 109 has a function of determining a distance threshold value that will be a trigger of pace learning. The distance threshold value determining unit 109 can determine a distance threshold value according to precision of the absolute position acquired by the absolute positioning unit 101. The distance threshold value determining unit 109 can decrease the distance threshold value when precision of the absolute position increases. The distance threshold value determining unit 109 can increase the distance threshold value when precision of the absolute position decreases.

The precision of the absolute position may be determined using map information that is stored in the map information storage unit 121. For example, precision of the absolute positioning by the GPS is lowered in an environment in which the sky is covered, for example, a street between buildings, an underpass, and a forest. Meanwhile, the precision of the absolute positioning by the GPS is improved in a residential area of single-family houses, a big park, and a wide road. Therefore, when the absolute positioning unit 101 performs absolute positioning by the GPS, the distance threshold value determining unit 109 recognizes a peripheral environment of the current location using the map information. The distance threshold value determining unit 109 may estimate the precision of the absolute position according to what kind of place the present location is and determine the distance threshold value. Alternatively, the distance threshold value determining unit 109 may determine the distance threshold value based on another GPS precision index. For example, the precision of the GPS positioning differs according to the number of satellites from which the GPS antenna receives GPS signals (number of positioning satellites that can be captured by the portable terminal 100). For this reason, the distance threshold value determining unit 109 may determine the distance threshold value based on the number of positioning satellites that can be captured by the portable terminal 100. The distance threshold value determining unit 109 may determine the distance threshold value based on a dilution of precision (DOP) of the GPS. The precision of the GPS positioning differs according to the reception strength of the GPS signals. For this reason, the distance threshold value determining unit 109 may determine the distance threshold value based on the reception strength of the GPS signals.

For example, when the absolute positioning unit 101 calculates the absolute position based on the reception strength of Wifi electric waves, the precision of the absolute position differs according to the number of base stations from which the absolute positioning unit 101 receives Wifi electric waves (number of base stations recognized from the portable terminal 100). Therefore, at this time, the distance threshold value determining unit 109 may estimate the precision of the absolute position based on the number of base stations recognized from the portable terminal 100 and determine the distance threshold value.

(Pace Calculating Unit 111)

The pace calculating unit 111 has a function of calculating a pace of the user when the user moves by the distance threshold value determined by the distance threshold value determining unit 109. The pace calculating unit 111 may divide the movement distance by the number of steps whenever the user moves by the distance threshold value and calculate the pace of the user. The pace calculating unit 111 may determine that the user has moved by the distance threshold value based on the absolute position acquired by the absolute positioning unit 101, and acquire the number of steps in a corresponding period from the counting unit 105 whenever the user moves by the distance threshold value. If the pace calculating unit 111 calculates the pace, the pace calculating unit 111 may calculate an average walking tempo in a corresponding period based on the walking tempo acquired from the walking tempo calculating unit 107, associate the average walking tempo with the pace, and supply the association result to the learning unit 113.

(Learning Unit 113)

The learning unit 113 has a function of learning a correspondence relation between the walking tempo and the pace based on the input walking tempo and pace. The learning unit 113 can make a correspondence table of the walking tempo and the pace and store the correspondence table in the correspondence table storage unit 123.

(Direction Acquiring Unit 115)

The direction acquiring unit 115 has a function of acquiring information of a direction in which the user moves. For example, the direction acquiring unit 115 may use a geomagnetic sensor.

(Autonomous Positioning Unit 117)

The autonomous positioning unit 117 has a function of calculating the relative position based on information acquired by the sensor and acquiring current position information. The autonomous positioning unit 117 may calculate the relative position from a specific spot based on the movement direction and the movement speed of the user. The autonomous positioning unit 117 may acquire a spot moved from the specific spot by the relative position as current position information. In this case, the specific spot may be a spot from which the absolute position is most recently acquired by the absolute positioning unit 101. Specifically, the autonomous positioning unit 117 may calculate the relative position based on the movement direction of the user acquired by the direction acquiring unit 115, the walking tempo of the user at a current point of time acquired by the walking tempo calculating unit 107, and the correspondence table of the walking tempo and the pace stored in the correspondence table storage unit 123. If the autonomous positioning unit 117 acquires the walking tempo of the user at the current point of time, the autonomous positioning unit 117 refers to the correspondence table to acquire information of the pace associated with the walking tempo. The autonomous positioning unit 117 may calculate the movement speed by multiplying the pace and the walking tempo. The autonomous positioning unit 117 calculates the relative position based on the movement speed and the direction and acquires current position information. The autonomous positioning unit 117 may calculate the current position information when the position information cannot be acquired by the absolute positioning unit 101.

(Navigation Unit 119)

The navigation unit 119 has a function of guiding the user along a path from the current spot to a predetermined spot. The navigation unit 119 may acquire the position information of the current spot from the absolute positioning unit 101. The navigation unit 119 may acquire the position information of the current spot from the autonomous positioning unit 117.

(Map Information Storage Unit 121)

The map information storage unit 121 has a function of storing map information. In this case, the stored map information may include road network data and point of interest (POI) information, in addition to topographic data. The map information may be stored previously in the map information storage unit 121. Alternatively, the map information may be appropriately stored in the map information storage unit 121 through a communication path or a removable storage medium.

(Correspondence Table Storage Unit 123)

The correspondence table storage unit 123 has a function of storing a correspondence table made by the learning unit 113. The correspondence table is information in which the pace of the user calculated by the pace calculating unit 111 and the walking tempo when the pace is calculated are associated with each other.

In this case, the map information storage unit 121 and the correspondence table storage unit 123 are described as separate storage units. However, the present technology is not limited to the above example. The map information storage unit 121 and the correspondence table storage unit 123 may be realized by an integrated storage device. Each of the map information storage unit 121 and the correspondence table 123 is a data storage device and may include a storage medium, a recording device that records data in the storage medium, a read device that reads data from the storage medium, and an erasing device that erases data recorded in the storage medium. In this case, a nonvolatile memory such as a flash memory, a magnetoresistive random access memory (MRAM), a ferroelectric random access memory (FeRAM), a phase change random access memory (PRAM), and an electronically erasable and programmable read only memory (EEPROM) or a magnetic recording medium such as a hard disk drive (HDD) may be used as the storage medium.

The example of the function of the portable terminal 100 according to this embodiment has been described. The structural elements may be configured using versatile members or circuits and may be configured using hardware specialized to functions of the structural elements. The function of each structural element may be executed by reading a control program from a storage medium such as a read only memory (ROM) or a random access memory (RAM) storing the control program describing a processing sequence for realizing the function of each structural element, analyzing the program, and executing the program by an arithmetic device such as a central processing unit (CPU). Therefore, a used configuration may be appropriately changed according to a technical level when this embodiment is carried out. Hereinafter, an example of a hardware configuration for realizing the function of the portable terminal 100 will be described.

A computer program for realizing each function of the portable terminal 100 according to this embodiment described above may be generated and can be mounted to a personal computer. In addition, a computer readable recording medium on which the computer program is stored may be provided. The recording medium may be a magnetic disk, an optical disc, a magneto optical disc, or a flash memory. The computer program may be distributed through a network without using the recording medium.

### 2-2. Example of Hardware Configuration

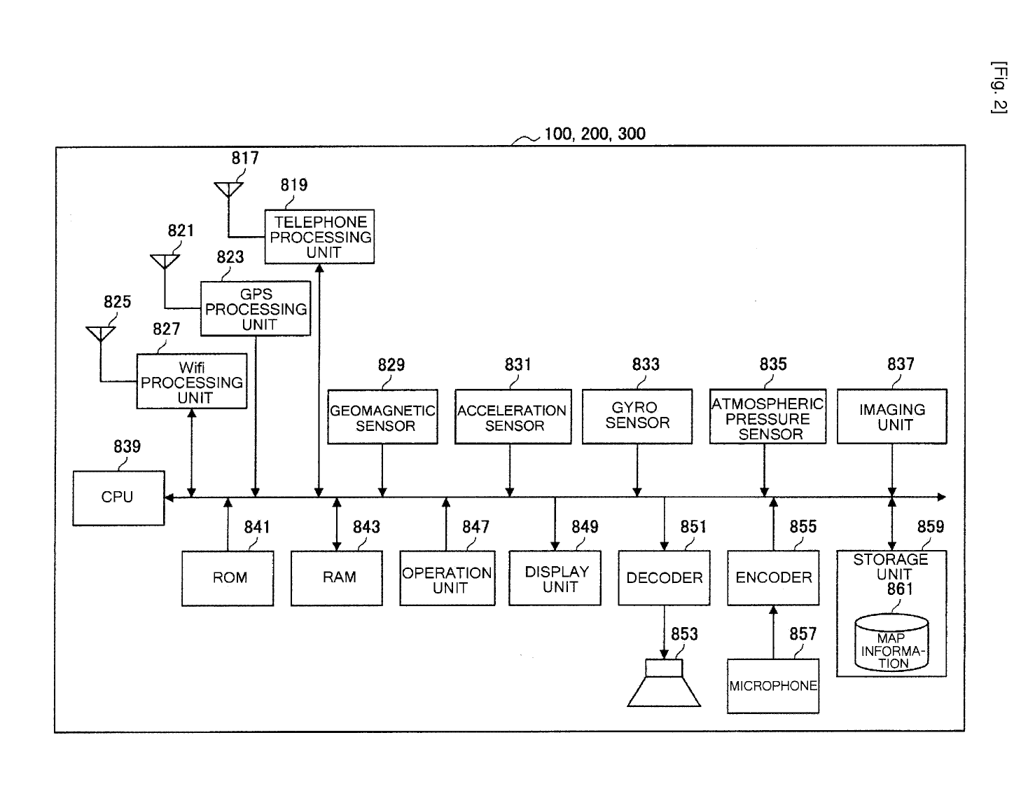

Next, an example of a hardware configuration of the portable terminal 100 according to the first embodiment of the present disclosure will be described with reference to FIG. 2. In this case, the hardware configuration of the portable terminal 100 according to the first embodiment of the present disclosure is described. However, the hardware configuration can be applied to a portable terminal 200 according to a second embodiment of the present disclosure and a portable terminal 300 according to a third embodiment of the present disclosure. FIG. 2 is a block diagram illustrating a hardware configuration of the portable terminal according to an embodiment of the present disclosure.

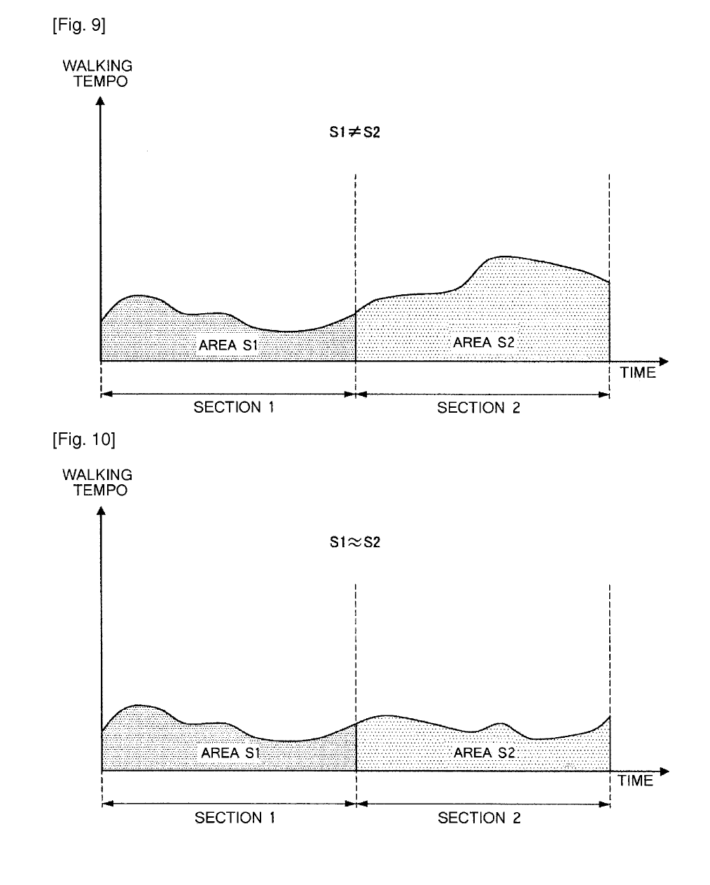

In this case, an example of the configuration of the portable terminal 100 will be described. Referring to FIG. 9, the portable terminal 100 includes a telephone network antenna 817, a telephone processing unit 819, a GPS antenna 821, a GPS processing unit 823, a Wifi antenna 825, a Wifi processing unit 827, a geomagnetic sensor 829, an acceleration sensor 831, a gyro sensor 833, an atmospheric pressure sensor 835, an imaging unit 837, a central processing unit (CPU) 839, a read only memory (ROM) 841, a random access memory (RAM) 843, an operation unit 847, a display unit 849, a decoder 851, a speaker 853, an encoder 855, a microphone 857, and a storage unit 859. The portable terminal 100 may be a smart phone.

(Telephone Network Antenna 817)

The telephone network antenna 817 is an example of an antenna that has a function of performing wireless connection with a portable telephone network for calling and communication. The telephone network antenna 817 may supply a call signal received through the portable telephone network to the telephone processing unit 819.

(Telephone Processing Unit 819)

The telephone processing unit 819 has a function of performing various signal processing with respect to a signal transmitted and received by the telephone network antenna 817. The telephone processing unit 819 may perform various signal processing with respect to a voice signal input through the microphone 857 and encoded by the encoder 855 and supply the voice signal to the telephone network antenna 817. The telephone processing unit 819 may perform the various signal processing with respect to the voice signal supplied from the telephone network antenna 819 and supply the voice signal to the decoder 851.

(GPS Antenna 821)

The GPS antenna 821 is an example of an antenna that receives a signal from a positioning satellite. The GPS antenna 821 can receive GPS signals from a plurality of GPS satellites and input the received GPS signals to the GPS processing unit 823.

(GPS Processing Unit 823)

The GPS processing unit 823 is an example of a calculating unit that calculates position information based on a signal received from a positioning satellite. The GPS processing unit 823 calculates current position information based on a plurality of GPS signals input from the GPS antenna 821 and outputs the calculated position information. Specifically, the GPS processing unit 823 calculates the position of each GPS satellite from orbital data of each GPS satellite and calculates the distance from each GPS satellite to the portable terminal 30 based on differential time of transmission time and reception time of the GPS signal. The GPS processing unit 823 may calculate the current three-dimensional position based on the calculated position of each GPS satellite and the distance from each GPS satellite to the portable terminal 30. In this case, the used orbital data of the GPS satellite may be included in the GPS signal. Alternatively, the orbital data of the GPS satellite may be acquired from an external server through the communication antenna 825.

(Wifi Antenna 825)

The Wifi antenna 825 is an antenna that has a function of transmitting and receiving a communication signal with a communication network such as a wireless local area network (LAN) according to a Wifi specification. The Wifi antenna 825 can supply the received signal to the communication processing unit 827.

(Wifi Processing Unit 827)

The Wifi processing unit 827 has a function of executing various signal processing with respect to a signal supplied from the Wifi antenna 825. The Wifi processing unit 827 can supply a digital signal generated from a supplied analog signal to the CPU 839.

(Geomagnetic Sensor 829)

The geomagnetic sensor 829 is a sensor that detects geomagnetism as a voltage value. The geomagnetic sensor 829 may be a triaxial geomagnetic sensor that detects geomagnetism of each of an X-axis direction, a Y-axis direction, and a Z-axis direction. The geomagnetic sensor 829 may supply detected geomagnetic data to the CPU 839.

(Acceleration Sensor 831)

The acceleration sensor 831 is a sensor that detects acceleration as a voltage value. The acceleration sensor 831 may be a triaxial acceleration sensor that detects acceleration along the X-axis direction, acceleration along the Y-axis direction, and acceleration along the Z-axis direction. The acceleration sensor 831 can supply detected acceleration data to the CPU 839.

(Gyro Sensor 833)

The gyro sensor 833 is one kind of measuring instrument that detects an angle or an angular velocity of an object. The gyro sensor 833 may be a triaxial gyro sensor that detects changing velocities (angular velocities) of rotation angles along X, Y, and Z axes as voltage values. The gyro sensor 833 may supply detected angular velocity data to the CPU 839.

(Atmospheric Pressure Sensor 835)

The atmospheric pressure sensor 835 is a sensor that detects a surrounding atmospheric pressure as a voltage value. The atmospheric pressure sensor 835 may detect an atmospheric pressure with a predetermined sampling frequency and may supply detected atmospheric pressure data to the CPU 839.

(Imaging Unit 837)

The imaging unit 837 has a function of imaging a still image or a moving image through a lens, according to control from the CPU 839. The imaging unit 837 may store the imaged image in the storage unit 859.

(CPU 839)

The CPU 839 functions as an arithmetic processing device and a control device and controls all operations in the portable terminal 30 according to various programs. The CPU 839 may be a microprocessor. The CPU 839 can realize various functions according to the various programs.

(ROM 841 and RAM 843)

The ROM 841 may store programs or arithmetic parameters that are used by the CPU 839. The RAM 843 may temporarily store programs used in execution of the CPU 839 or parameters to be appropriately changed in execution of the programs.

(Operation Unit 847)

The operation unit 847 has a function of generating an input signal to perform an operation desired by a user 5. The operation unit 847 may include an input unit such as a touch sensor, a mouse, a keyboard, a button, a microphone, a switch, and a lever for the user 5 to input information and an input control circuit that generates the input signal based on an input from the user 5 and outputs the input signal to the CPU 839.

(Display Unit 849)

The display unit 849 is an example of an output device and may be a display device such as a liquid crystal display (LCD) device and an organic light emitting diode (OLED) display device. The display unit 849 may display a screen to the user 5 to provide information to the user 5.

(Decoder 851 and Speaker 853)

The decoder 851 has a function of performing decoding and analog conversion of input data according to the control from the CPU 839. The decoder 851 may perform decoding and analog conversion of voice data input through the telephone network antenna 817 and the telephone processing unit 819 and output a voice signal to the speaker 853. The decoder 851 may perform decoding and analog conversion of voice data input through the Wifi antenna 825 and the Wifi processing unit 827 and output a voice signal to the speaker 853. The speaker 853 may output a voice based on the voice signal supplied from the decoder 851.

(Encoder 855 and Microphone 857)

The encoder 855 has a function of performing digital conversion and encoding of input data according to the control from the CPU 839. The encoder 855 may perform digital conversion and encoding of a voice signal input from the microphone 857 and output voice data. The microphone 857 may collect a voice and output the collected voice as a voice signal.

(Storage Unit 859)

The storage unit 859 is a data storage device and may include a storage medium, a recording device that records data in the storage medium, a read device that reads data from the storage medium, and an erasing device that erases data recorded in the storage medium. In this case, a nonvolatile memory such as a flash memory, a magnetoresistive random access memory (MRAM), a ferroelectric random access memory (FeRAM), a phase change random access memory (PRAM), and an electronically erasable and programmable read only memory (EEPROM) or a magnetic recording medium such as a hard disk drive (HDD) may be used as the storage medium. The storage unit 857 may store the map information 861. The storage unit 857 may store a correspondence table.

### 2-3. Example of Operation

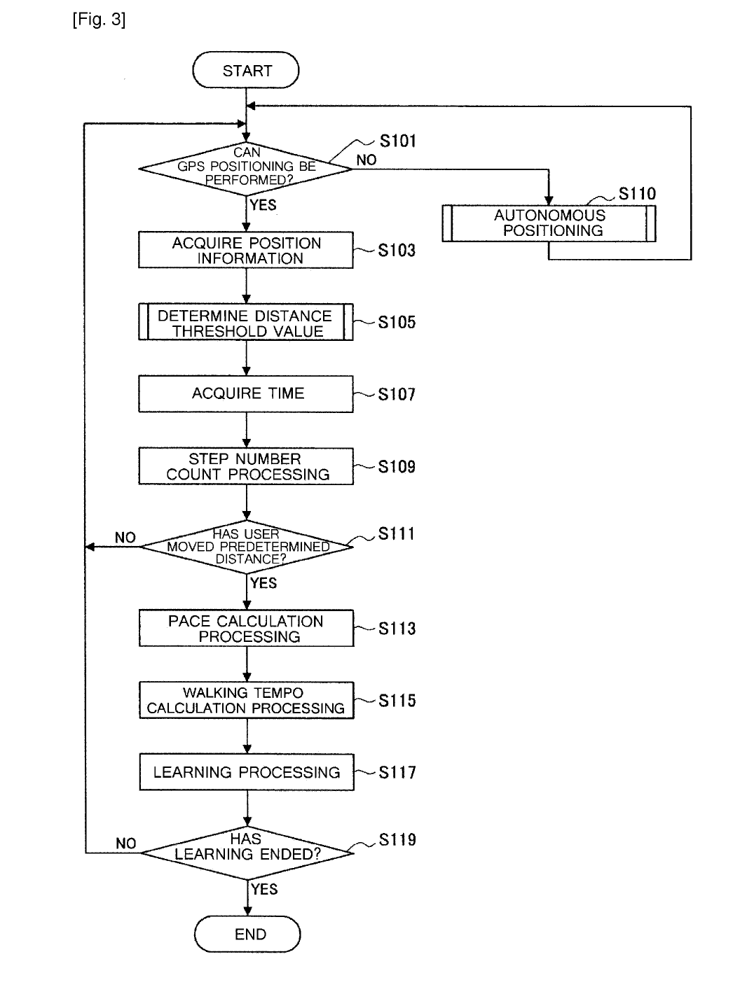

Next, an operation of the portable terminal 100 according to the first embodiment of the present disclosure will be described with reference to FIG. 3. FIG. 3 is a flowchart of an example of the operation of the portable terminal according to the first embodiment of the present disclosure.

First, the portable terminal 100 determines whether GPS positioning may be performed (S101). In this case, when it is determined that the GPS positioning may be performed, the absolute positioning unit 101 of the portable terminal 100 acquires position information at a current point of time (S103). The distance threshold value determining unit 109 determines the distance threshold value (S105). The determination of the distance threshold value will be described in detail below.

The counting unit 105 acquires time information at the current point of time (S107). The counting unit 105 counts time that passes from the current point of time and starts step number count processing (S109). The pace calculating unit 111 determines whether the user has moved the predetermined distance after the position information is acquired in step S103 (S111). In this case, the distance threshold value that is determined in step S105 is used as the predetermined distance. The step number count processing of step S109 is continuously executed until it is determined that the user has moved the predetermined distance in step S111.

When it is determined that the user has moved the predetermined distance, the pace calculating unit 111 executes pace calculation processing (S113). Specifically, the pace calculating unit 111 may divide the movement distance by the number of steps and calculate a pace to be the movement distance per step. In this case, the pace calculating unit 113 makes the walking tempo calculating unit 107 calculate the walking tempo during the movement (S115). In this case, the calculated walking tempo may be an average walking tempo while the user moves the movement distance.

The learning unit 113 learns a correspondence relation between the pace and the walking tempo using the pace calculated in step S113 and the walking tempo calculated in step S115 (S117). Next, the learning unit 113 determines whether learning has ended (S119). When it is determined that the learning has ended in step S119, the flow ends. When it is determined that the learning has not ended in step S119, the process returns to step S101 and the process is continued. When it is determined that the GPS positioning cannot be performed in step S101, the autonomous positioning unit 117 of the portable terminal 100 may perform the autonomous positioning (S110).

### 2-4. Determination of Distance Threshold Value

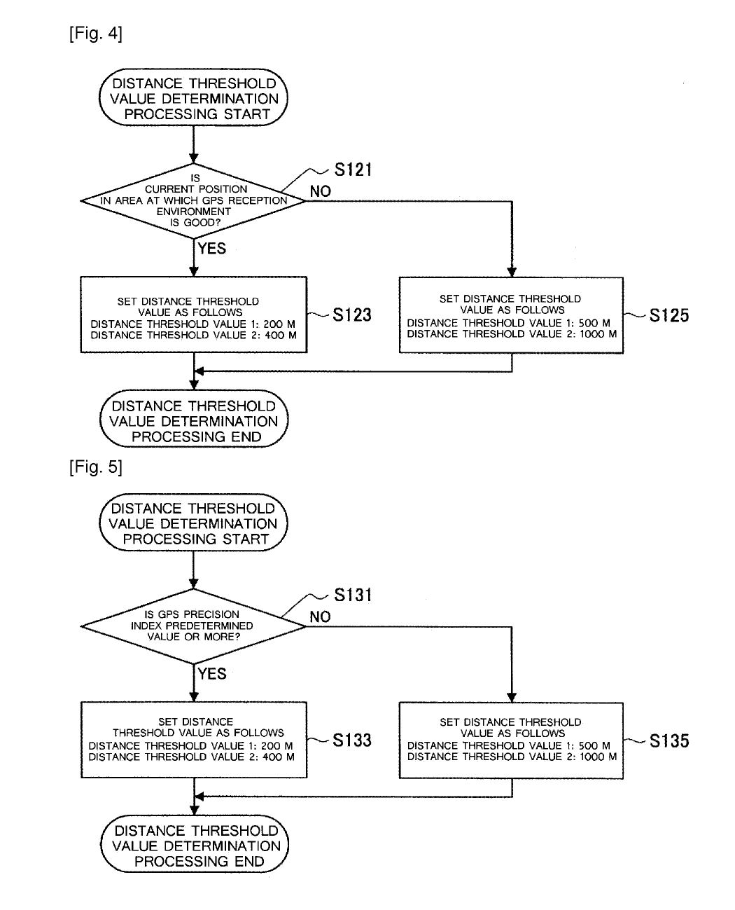

In this case, the determination of the distance threshold value in step S105 of FIG. 3 will be described in detail with reference to FIGS. 4 and 5. FIG. 4 is a flowchart of an example of an operation of distance threshold value determination processing of the portable terminal according to the same embodiment. FIG. 5 is a flowchart of another example of the operation of the distance threshold value determination processing of the portable terminal according to the same embodiment.

First, referring to FIG. 4, the distance threshold value determining unit 109 determines whether the current position is included in an area in which a GPS reception environment is good (S121). In this case, the distance threshold value determining unit 109 may perform the determination of step S121 using the map information. The distance threshold value determining unit 109 recognizes a peripheral situation of the current location using the map information. For example, when a residential area of single-family houses, a big park, and a wide road are around the current location, the distance threshold value determining unit 109 may determine that the current position is included in the area in which the GPS reception environment is good. When there are a street between buildings, an underpass, a streetcar, and a forest around the current location, the distance threshold value determining unit 109 may determine that the current position is included in an area in which the GPS reception environment is bad.

When it is determined that the current position is included in the area in which the GPS reception environment is good in step S121, the distance threshold value determining unit 109 may set a first distance threshold value to 200 m and set a second distance threshold value to 400 m (S123). Meanwhile, when it is determined that the current position is not included in the area in which the GPS reception environment is good in step S121, the distance threshold value determining unit 109 may set the first distance threshold value to 500 m and set the second distance threshold value to 1000 m (S125).

The method of determining the distance threshold value using the map information has been described with reference to FIG. 4. However, the present disclosure is not limited to the above example. Next, a method of determining a distance threshold value based on a GPS precision index will be described with reference to FIG. 5.

First, the distance threshold value determining unit 109 determines whether the GPS precision index is a predetermined value or more (S131). In this case, the number of captured positioning satellites, the DOP, and the reception strength of the GPS signal may be used as the GPS precision index. When the precision index is the predetermined value or more, the distance threshold value determining unit 109 may set the first distance threshold value to 200 m and set the second distance threshold value to 400 m (S133). Meanwhile, when the precision index is less than the predetermined value, the distance threshold value determining unit 109 may set the first distance threshold value to 500 m and set the second distance threshold value to 1000 m (S135).

The example of the case in which the absolute positing unit 101 performs the GPS positioning has been described. However, the present disclosure is not limited to the above example. For example, when the absolute positioning unit 101 performs positioning other than the GPS positioning, the distance threshold value may be determined based on appropriate positioning precision according to a positioning method. However, the distance threshold value described in this case is only exemplary and various values may be used according to other environments. When the positioning precision is high, the distance threshold value is set to be smaller than the distance threshold value when the positioning precision is low. In this case, the distance threshold value is selected in the two steps and is determined. However, the present disclosure is not limited to the above example. Various values may be used according to positioning precisions.

### 2-5. Autonomous Positioning

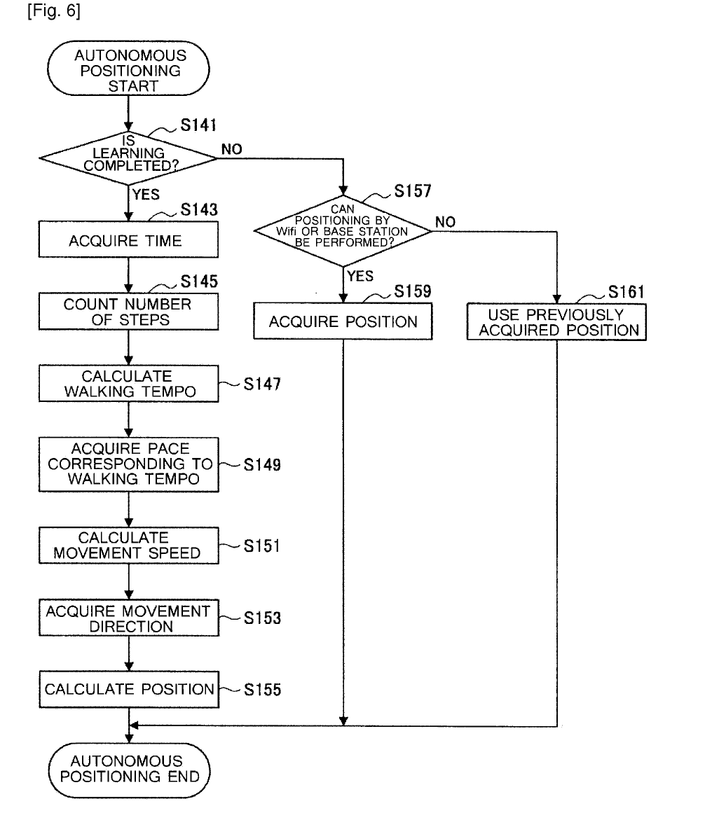

Next, the autonomous positioning processing in step S110 of FIG. 3 will be described in detail with reference to FIG. 6. FIG. 6 is a flowchart of an example of an autonomous positioning operation of the portable terminal according to the same embodiment.

First, the autonomous positioning unit 117 determines whether the relation between the walking tempo and the pace is already learned (S141). For example, the autonomous positioning unit 117 may perform the determination based on whether the correspondence table is stored in the correspondence table storage unit 123. When it is determined that the relation between the walking tempo and the pace is already learned in the determination of step S141, the autonomous positioning unit 117 acquires time (S143). The autonomous positioning unit 117 makes the counting unit 105 count the number of steps from a point of time at which the time is acquired (S145). The autonomous positioning unit 117 makes the walking tempo calculating unit 107 calculate the walking tempo (S147).

In this case, the autonomous positioning unit 117 acquires the pace corresponding to the walking tempo calculated in step S147 by referring to the correspondence table (S149). The autonomous positioning unit 117 calculates the movement speed using the pace acquired in step S149 (S151). In this case, the movement speed is calculated by multiplying the pace by the walking tempo. The autonomous positioning unit 117 acquires the movement direction of the user from the direction acquiring unit 115 (S153). The autonomous positioning unit 117 calculates the current position based on the movement speed calculated in step S151 and the movement direction acquired in step S153 (S155). Specifically, the autonomous positioning unit 117 calculates the relative position from a spot shown by the absolute position finally obtained by the GPS positioning, based on the movement speed and the movement direction. The autonomous positioning unit 117 calculates the current position information using the absolute position and the relative position.

Meanwhile, when it is determined that the relation between the walking tempo and the pace is not yet learned in the determination of step S141, the autonomous positioning unit 117 determines whether positioning by the Wifi or the base station may be performed (S157).

### 2-6. Example of Effect

As described above, the portable terminal 100 according to the first embodiment of the present disclosure uses the distance as the trigger to calculate the pace, instead of the time. By this configuration, the movement distance that becomes the calculation unit of the pace may be set to the distance in which sufficient positioning precision may be maintained. When the time is used as the trigger, if time during which the user is stopped is included, the movement distance that becomes the calculation unit of the pace is decreased by the corresponding time. For this reason, the sufficient distance may not be secured as the movement distance becoming the calculation unit and the precision of the pace may be greatly lowered when the positioning precision is lowered. In the configuration according to this embodiment, because the movement of the user by the predetermined distance threshold value is used as the trigger, lowering of the precision of the pace may be decreased.

The distance threshold value may be changed according to the positioning precision. Specifically, when the positioning precision is high, the distance threshold value may be set to be smaller than the distance threshold value when the positioning precision is low. By this configuration, the appropriate distance threshold value is selected according to the positioning precision. Therefore, learning precision of the correspondence relation between the walking tempo and the pace is improved.

The portable terminal 100 determines whether the user is walking and counts the period during which the user is walking as the movement time. That is, the portable terminal 100 does not include the period during which the user is stopped in the movement time. By this configuration, when the user is stopped, the precision of the walking tempo may be prevented from being lowered.

### 3. Second Embodiment

### 3-1. Functional Configuration

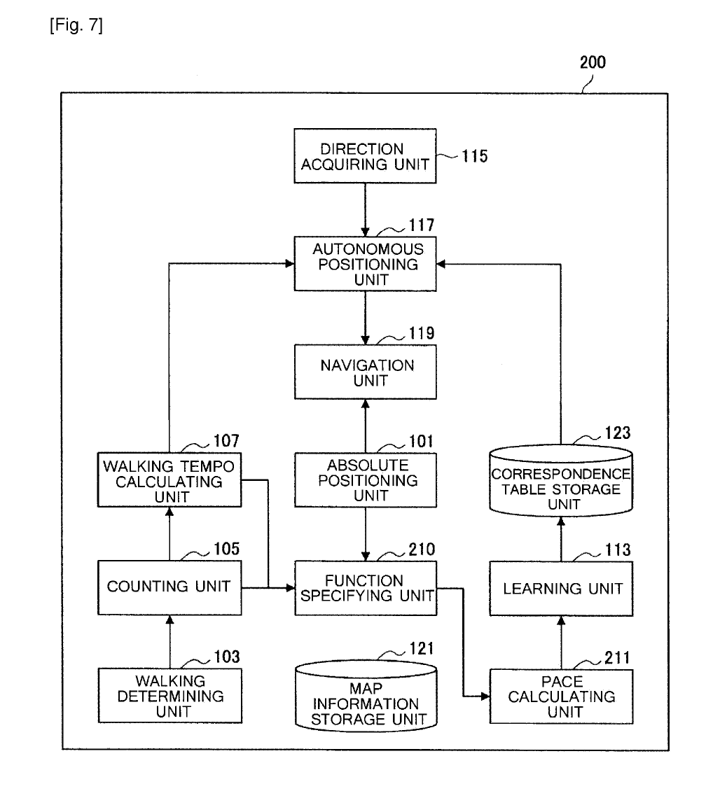

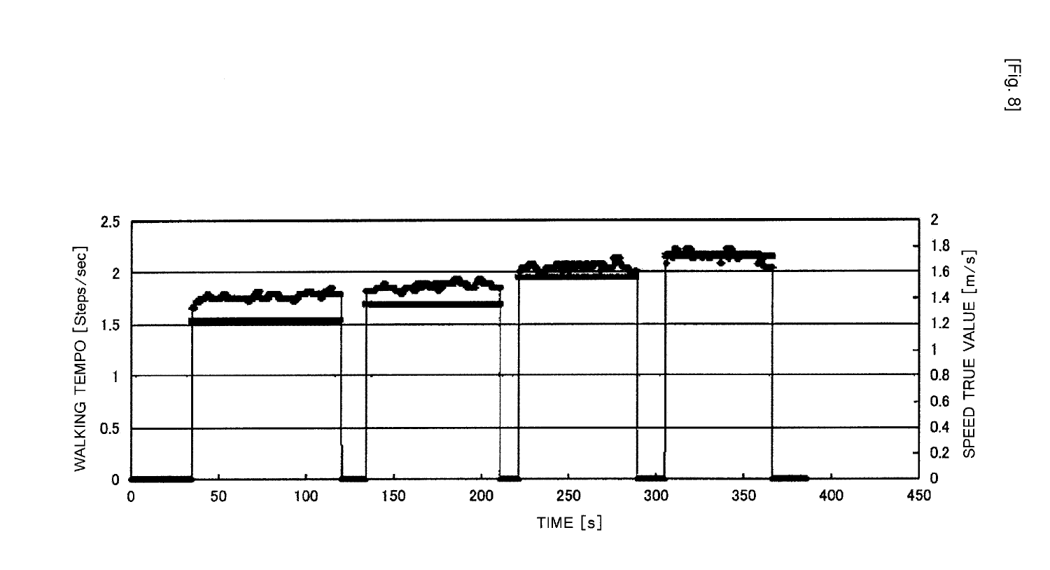

Next, a functional configuration of a portable terminal according to a second embodiment of the present disclosure will be described with reference to FIGS. 7 to 10. FIG. 7 is a block diagram illustrating the functional configuration of the portable terminal according to the second embodiment of the present disclosure. FIG. 8 is an explanatory diagram for explaining an outline of a function of the portable terminal according to the same embodiment. FIG. 9 is an explanatory diagram for explaining the case in which a function may be specified in making a correspondence table of the portable terminal according to the same embodiment. FIG. 10 is an explanatory diagram for explaining the case in which a function cannot be specified in making a correspondence table of the portable terminal according to the same embodiment.

The portable terminal 200 is an information processing apparatus that has an autonomous navigation function during walking. The portable terminal 200 may be an information processing apparatus such as a mobile phone, a personal digital assistant (PDA), a smart phone, a portable music reproducing apparatus, a portable video processing apparatus, a portable game machine, a portable personal computer (PC) (including a notebook PC and a tablet type PC), and a navigation apparatus including a personal navigation device (PND). In the following description of this embodiment, the user who carries the portable terminal 200 is simply referred to as the user.

The portable terminal 200 is an information processing apparatus that has a function of assuming a function between a walking tempo and a movement speed, specifying coefficients included in the function, and learning a relation between the walking tempo and the movement speed or the pace.

The portable terminal 200 mainly includes an absolute positioning unit 101, a walking determining unit 103, a counting unit 105, a walking tempo calculating unit 107, a function specifying unit 210, a pace calculating unit 211, a learning unit 113, a direction acquiring unit 115, an autonomous positioning unit 117, a navigation unit 119, a map information storage unit 121, and a correspondence table storage unit 123.

The configuration of the portable terminal 200 according to this embodiment partially overlaps the configuration of the portable terminal 100 according to the first embodiment of the present disclosure. For this reason, description of the same structural elements as those of the portable terminal 100 is not repeated here and the differences are mainly described.

(Function Specifying Unit 210)

The function specifying unit 210 has a function of specifying a function assumed as the function between the walking tempo and the movement speed. In this case, the assumption that the walking tempo and the speed are correlated with each other will be described with reference to FIG. 8. FIG. 8 illustrates a value of an actually measured speed and a walking tempo detected at that time. As such, it can be seen that the walking tempo and the speed are correlated with each other.

In this case, it is assumed that a relation of the following expression 2 is realized between a walking tempo f and a movement speed v.

v=a×\hat{f}+b (2)

where a and b denote learning coefficients.

In this case, it is assumed that a primary correlation is realized between the walking tempo f and the movement speed v. However, the present disclosure is not limited to the above example. For example, it may be assumed that a secondary or higher correlation is realized between the walking tempo f and the movement speed v. Alternatively, it may be assumed that a correlation shown by a triangular function is realized between the walking tempo f and the movement speed v.

At this time, a relation of the following expression 3 is realized among a movement distance X, a walking tempo f, and a movement time T, from the expression 2.

$$\begin{matrix}{X}^{⋒} = {\sum }^{t} v \\ = {\sum }^{t} ( a \times {f}^{⋒} + b ) \\ = a \times {\sum }^{t} {f}^{⋒} + b \times {T}^{⋒}\end{matrix} \qquad ( 3 )$$

In this case, the movement distance X is acquired based on position information acquired by the absolute positioning unit 101. The walking tempo f is calculated by the walking tempo calculating unit 107. The movement time T is counted by the counting unit 105. Therefore, values of the movement distance X, the walking tempo f, and the movement time T that correspond to two sections are acquired and the coefficients a and b are calculated. The function specifying unit 210 may classify the walking tempo f and integrate the walking tempo for each class. The classification of the walking tempo f will be described in detail below.

The function specifying unit 210 may acquire the movement distance X and the movement time T for every predetermined time, solve an equation using the integrated walking tempo f, calculate the coefficients a and b, and specify the assumed function. However, the coefficients a and b may not be calculated.

For example, as illustrated in FIG. 9, when average tempos for every section are different from each other (integration values of the walking tempos become different: S1, S2 are different values), the function specifying unit 210 may solve the equation and may specify the function. However, as illustrated in FIG. 10, when the average tempos for every section become approximately equal to each other (integration values of the walking tempos become approximately equal to each other: S1, S2 are approximately same values), the function specifying unit 210 cannot solve the equation and cannot specify the function.

For example, the equation for calculating the coefficients a and b is as follows.

m₁a+m₂b=m₃ (4)

n₁a+n₂b=n₃ (5)

Meanwhile, a condition in which the equation is not solved (=linear dependence) is represented by the following expression.

$$\frac{{m}_{1}}{{n}_{1}} - \frac{{m}_{2}}{{n}_{2}} = 0 \qquad ( 6 )$$

In actuality, because noise is included, the condition becomes a condition in which a predetermined width is included, as represented by the following expression 7.

$$\begin{matrix}\vert \frac{{m}_{1}}{{n}_{1}} - \frac{{m}_{2}}{{n}_{2}} \vert < Δ & ex . Δ = 0.5\end{matrix} \qquad ( 7 )$$

Therefore, when the function specifying unit 210 may solve the equation, the function specifying unit 210 supplies the specified function to the pace calculating unit 211. When the function specifying unit 210 cannot solve the equation, the function specifying unit 210 may provide information indicating that the function is not specified to the pace calculating unit 211.

(Pace Calculating Unit 211)

The pace calculating unit 211 has a function of calculating a pace of the user. The pace calculating unit 211 substitutes the previously calculated walking tempo value for the function specified by the function specifying unit 210 and calculates the speed of each time. The pace calculating unit 211 may calculate the pace of each time using the expression 1 realized between the speed v and the pace k.

v=k′f (1)

When the function specifying unit 210 cannot specify the function, the pace calculating unit 211 may calculate the pace using the movement distance and the movement time. The pace calculating unit 211 may calculate the pace for each class to be generated by classifying the walking tempo to be described in detail below.

### 3-2. Example of Operation

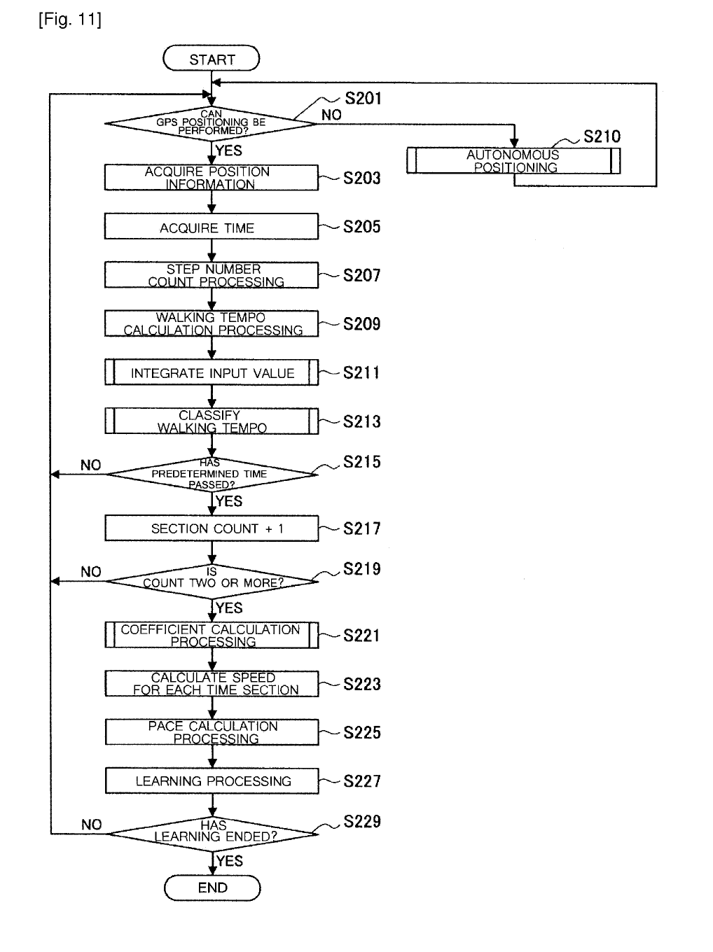

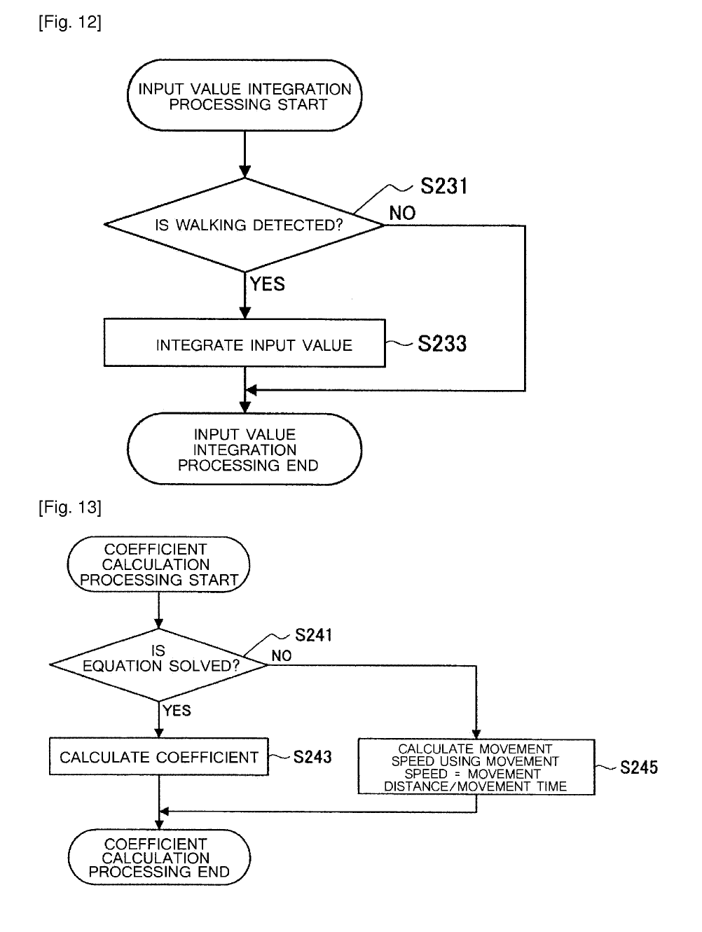

Next, an operation of the portable terminal according to the second embodiment of the present disclosure will be described with reference to FIGS. 11 to 13. FIG. 11 is a flowchart of an example of an operation of the portable terminal according to the same embodiment. FIG. 12 is a flowchart of an example of an operation of input value integration processing of the portable terminal according to the same embodiment. FIG. 13 is a flowchart of an example of an operation of coefficient calculation processing of the portable terminal according to the same embodiment.

First, the portable terminal 200 determines whether GPS positioning may be performed (S201). In this case, when it is determined that the GPS positioning may be performed, the absolute positioning unit 101 of the portable terminal 200 acquires position information at a current point of time (S203). The counting unit 105 acquires time information at the current point of time (S205). The counting unit 105 counts time that passes from the current point of time and starts step number count processing (S207). The walking tempo calculating unit 107 calculates the walking tempo using the passed time and the number of steps counted by the counting unit 105 (S209).

The function specifying unit 210 integrates the input value (S211). Input value integration processing of step S211 will be described with reference to FIG. 12. First, the function specifying unit 210 determines whether the walking determining unit 103 detects that the user is walking (S231). The function specifying unit 210 integrates the input value only when the walking is detected in the determination of step S241 (S233). In this case, the walking tempo is used as the input value.

Returning to FIG. 11, the description continues. Next, the function specifying unit 210 executes the walking tempo classification processing (S213). The function specifying unit 210 determines whether a predetermined time has passed (S215). In this case, when it is determined that the predetermined time has passed, the function specifying unit 210 increases a section count by 1 (S217). Next, the function specifying unit 210 determines whether the section count is 2 or more (S219).

When it is determined that the section count is 2 or more in the determination of step S219, the function specifying unit 219 specifies the function by executing the coefficient calculation processing (S221). The coefficient calculation processing in step S221 is illustrated in detail in FIG. 13. Referring to FIG. 13, first, the function specifying unit 210 determines whether the equation is solved (S241). In the above example using the primary correlation, the determination may be performed based on whether the difference of the integration values of the walking tempos f in the two sections is a predetermined value or more. When it is determined that the equation is solved in the determination of step S231, the function specifying unit 210 calculates the coefficients by solving the equation (S243). Meanwhile, when it is determined that the equation cannot be solved in the determination of step S231, the function specifying unit 210 calculates the movement speed by dividing the movement distance by the movement time (S245).

Returning to FIG. 11, the description continues. Next, the pace calculating unit 211 calculates the movement speed for each time section (S223). Next, the pace calculating unit 211 calculates the pace using the movement speed (S225). Next, the learning unit 113 learns a correspondence relation between the pace for each time section at which the movement speed is calculated and the walking tempo for each time section (S227). Next, the learning unit 113 determines whether learning has ended (S229). When it is determined that the learning has ended in step S229, the flow ends. Meanwhile, when it is determined that the learning has not ended in step S229, the process returns to step S201 and the process is continued. When it is determined that the GPS positioning cannot be performed in step S201, the autonomous positioning unit 117 of the portable terminal 200 may perform the autonomous positioning (S210). The autonomous positioning that is performed in step S210 is the same as the processing described with reference to FIG. 6.

### 3-3. Classification of Walking Tempo

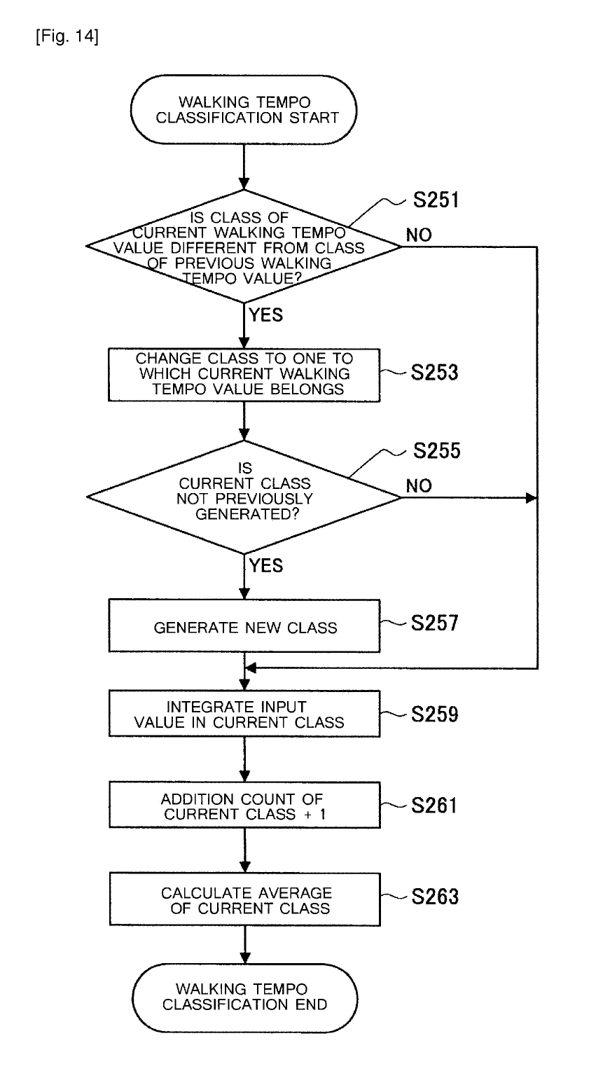

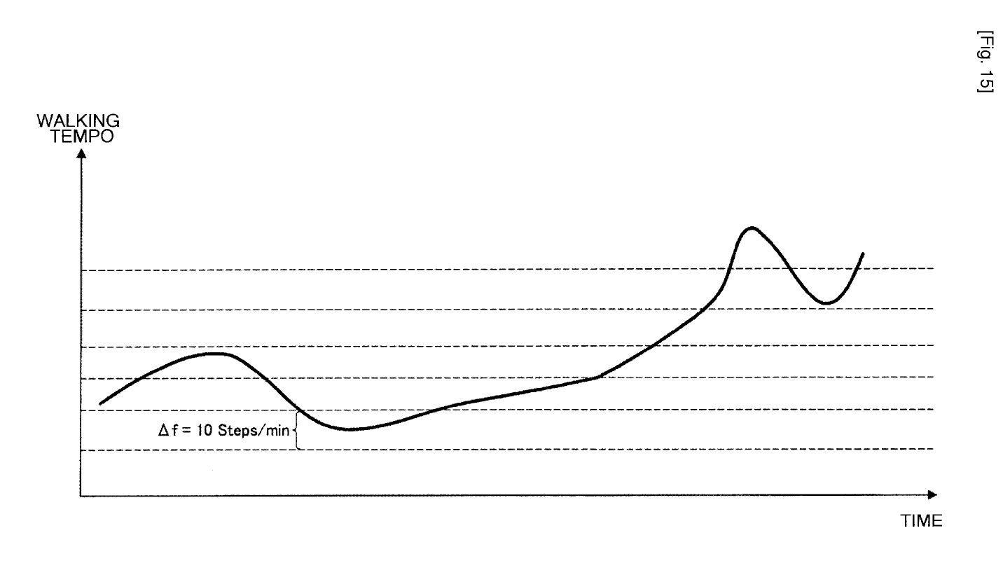

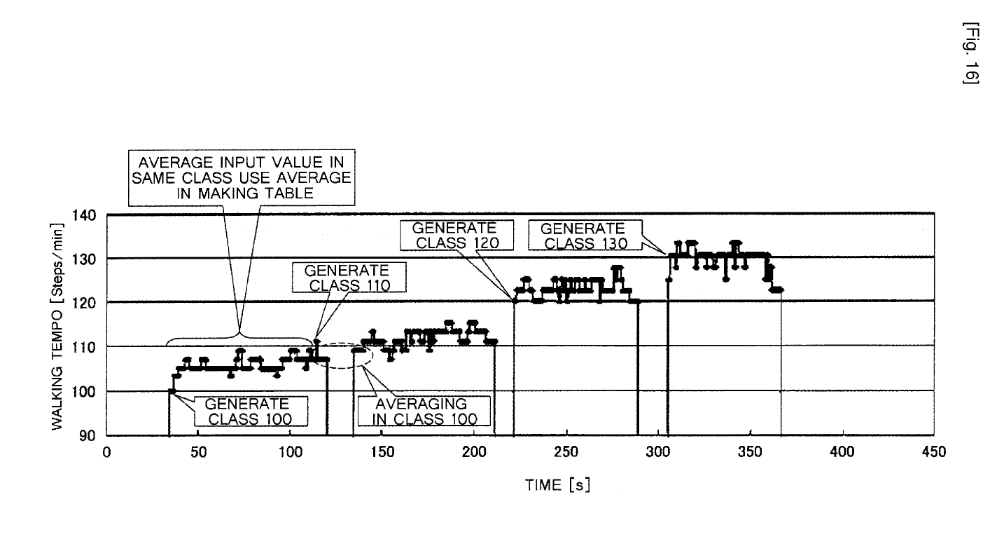

In this case, the classification of the walking tempo in step S213 of FIG. 11 will be described in detail with reference to FIGS. 14 to 16. FIG. 14 is a flowchart of an example of an operation of walking tempo classification processing of the portable terminal according to the same embodiment. FIG. 15 is an explanatory diagram for explaining the walking tempo classification processing of the portable terminal according to the same embodiment. FIG. 16 is an explanatory diagram for explaining a specific example of the walking tempo classification processing of the portable terminal according to the same embodiment.

First, referring to FIG. 14, the function specifying unit 210 determines whether a class of a current walking tempo value is different from a class of the previous walking tempo value (S251). In this case, a previously set condition is used as a class division condition. For example, as illustrated in FIG. 15, the walking tempos may be classified at an equivalent interval Df=10 steps/min and the walking tempos in the same class may be handled as the same walking tempos. If the walking tempo is handled as the continuous amount, an information amount of a table may become enormous. For this reason, the walking tempos are classified and an average tempo value is calculated for each class. As such, the information amount may be decreased by classifying the walking tempos.

Returning to FIG. 14, the description continues. When it is determined that the walking tempo value of the class different from the class of the previous walking tempo is obtained in the determination of step S251, the function specifying unit 210 changes the current class to a class to which the current walking tempo value belongs (S253). The function specifying unit 210 determines whether the current class is a previously ungenerated class (S255). When it is determined that the current class is a previously ungenerated class in the determination of step S255, the function specifying unit 210 generates a new class (S257).

The function specifying unit 210 integrates an input value in the current class (S259). Meanwhile, when it is determined that the class of the current walking tempo value is equal to the class of the previous walking tempo value in the determination of step S251, the process of step S259 is executed. When it is determined that the current class is a previously generated class in the determination of step S255, the process of step S257 is omitted and the process of step S259 is executed. The function specifying unit 210 increases an addition count of the current class by 1 (S261). The function specifying unit 210 calculates an average walking tempo value of the current class (S263).

Referring to the specific example of FIG. 16, when the current walking tempo value is more than 100 steps/min, the function specifying unit 210 may generate a class 100. Then, the function specifying unit 210 may integrate a green zone in the current class 100, when the walking tempo value changes in a range of 100 to 110 steps/min. When the walking tempo value is more than 110, a new class 110 is generated. Then, the walking tempo value becomes less than 110 again in FIG. 16. For this reason, the function specifying unit 210 returns the current class to the class 100 and restarts averaging processing in the class 100.

### 3-4. Example of Effect

As described above, in the portable terminal 200 according to the second embodiment of the present disclosure, the function realized between the movement speed and the walking tempo is assumed on the assumption that the movement speed and the walking tempo are correlated with each other. The portable terminal 200 specifies the function by calculating the coefficients included in the function from the value acquired using the sensor. The portable terminal 200 may calculate the pace corresponding to each walking tempo value using the function. In a method using a time average of the pace and the walking tempo in one section of the learning, a correlation relation of one point is calculated in the section. For this reason, in a situation in which the walking tempo variously changes in one section, an error of the calculated pace may increase and a range of the walking tempo in the correspondence table may be narrower than a range of the actual walking tempo. However, according to the configuration of the portable terminal 200, in a situation in which the walking tempo changes in the learning section, the movement speed (or the pace) having high precision corresponding to each walking tempo may be calculated. Therefore, precision of the pace may be improved and the range of the walking tempo in the correspondence table may be approximated to the range of the actual walking tempo.

At this time, the walking tempos may be classified and an input value may be integrated for each class. As described above, the portable terminal 200 may calculate the movement speed (or the pace) with respect to each walking tempo. For this reason, when the walking tempo is handled as the continuous amount, the information amount of the correspondence table may become enormous. Therefore, the walking tempos may be classified and the movement speed (or the pace) corresponding to the average of the walking tempo values in the class having the certain width may be calculated. According to this configuration, the information amount of the correspondence table may be decreased.

### 4. Third Embodiment

### 4-1. Functional Configuration

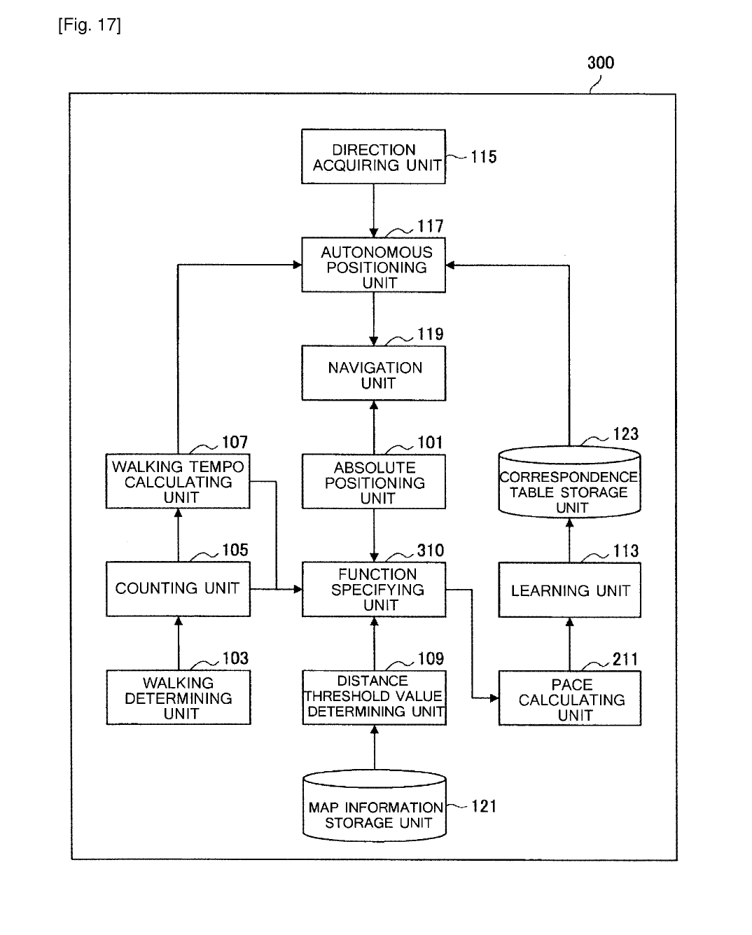

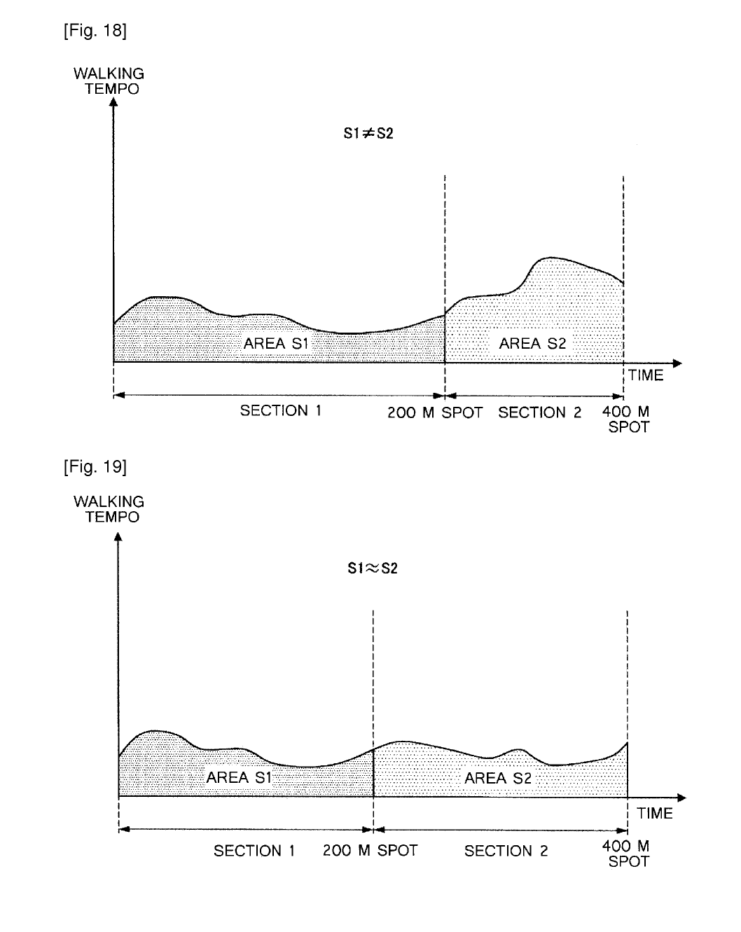

Next, a configuration of a portable terminal according to a third embodiment of the present disclosure will be described with reference to FIGS. 17 to 19. FIG. 17 is a block diagram illustrating the functional configuration of the portable terminal according to the third embodiment of the present disclosure. FIG. 18 is an explanatory diagram for explaining the case in which a function may be specified in making a correspondence table of the portable terminal according to the same embodiment. FIG. 19 is an explanatory diagram for explaining the case in which a function cannot be specified in making a correspondence table of the portable terminal according to the same embodiment.

The portable terminal 300 is an information processing apparatus that has an autonomous navigation function during walking. The portable terminal 300 may be an information processing apparatus such as a mobile phone, a personal digital assistant (PDA), a smart phone, a portable music reproducing apparatus, a portable video processing apparatus, a portable game machine, a portable personal computer (PC) (including a notebook PC and a tablet type PC), and a navigation apparatus including a personal navigation device (PND). In the following description of this embodiment, the user who carries the portable terminal 300 is simply referred to as the user.

The portable terminal 300 is an information processing apparatus that has the configuration described in the first embodiment in which the predetermined distance is used as the trigger to calculate the pace and the configuration described in the second embodiment in which the function realized between the walking tempo and the movement speed is assumed and the movement speed (or the pace) corresponding to each walking tempo is calculated.

The portable terminal 300 mainly includes an absolute positioning unit 101, a walking determining unit 103, a counting unit 105, a walking tempo calculating unit 107, a distance threshold value determining unit 109, a function specifying unit 310, a pace calculating unit 211, a learning unit 113, a direction acquiring unit 115, an autonomous positioning unit 117, a navigation unit 119, a map information storage unit 121, and a correspondence table storage unit 123.

The configuration of the portable terminal 300 according to this embodiment partially overlaps the configuration of the portable terminal 100 according to the first embodiment of the present disclosure and the configuration of the portable terminal 200 according to the second embodiment of the present disclosure. For this reason, the same structural elements as those of the portable terminal 100 or 200 are denoted with the same reference signs, description thereof is not repeated here, and the differences will be mainly described.

(Function Specifying Unit 310)

The function specifying unit 310 has a function of specifying a function assumed as the function between the walking tempo and the movement speed. The function specifying unit 310 sets the predetermined distance determined by the distance threshold value determining unit 109 as one section, substitutes an acquired value for an equation, calculates coefficients included in the function, and specifies the function.

In this case, it is assumed that a relation of the following expression 2 is realized between a walking tempo f and a movement speed v, similar to the second embodiment.

v=a×\hat{f}+b (2)

where a and b denote learning coefficients.

At this time, a relation of the following expression 3 is realized among a movement distance X, a walking tempo f, and a movement time T, from the expression 2.

$$\begin{matrix}{X}^{⋒} = {\sum }^{t} v \\ = {\sum }^{t} ( a \times {f}^{⋒} + b ) \\ = a \times {\sum }^{t} {f}^{⋒} + b \times {T}^{⋒}\end{matrix} \qquad ( 3 )$$

In this case, the movement distance X is acquired based on position information acquired by the absolute positioning unit 101. The walking tempo f is calculated by the walking tempo calculating unit 107. The movement time T is counted by the counting unit 105. Therefore, values of the movement distance X, the walking tempo f, and the movement time T that correspond to two sections are acquired and the coefficients a and b are calculated. The function specifying unit 310 may classify the walking tempo f and may integrate the walking tempo for each class. The classification of the walking tempo f is as described in the second embodiment of the present disclosure with reference to FIGS. 14 to 16.

The function specifying unit 310 sets the predetermined distance determined by the distance threshold value determining unit 109 as one section as described above, acquires the movement distance X and the movement time T, solves the equation using the integrated walking tempo f, calculates the coefficients a and b, and specifies the assumed function. However, the coefficients a and b may not be calculated.

For example, as illustrated in FIG. 18, when average tempos for every section differ from each other (integration values of the walking tempos are different: S1 &sup1; S2), the function specifying unit 310 may solve the equation and may specify the function. However, as illustrated in FIG. 19, when the average tempos for every section become approximately equal to each other (integration values of the walking tempos become approximately equal to each other: S1 &raquo; S2), the function specifying unit 310 cannot solve the equation and cannot specify the function.

Therefore, when the function specifying unit 310 may solve the equation, the function specifying unit 310 supplies the specified function to the pace calculating unit 211. When the function specifying unit 310 cannot solve the equation, the function specifying unit 310 may provide information indicating that the function is not specified to the pace calculating unit 211.

### 4-2. Example of Operation

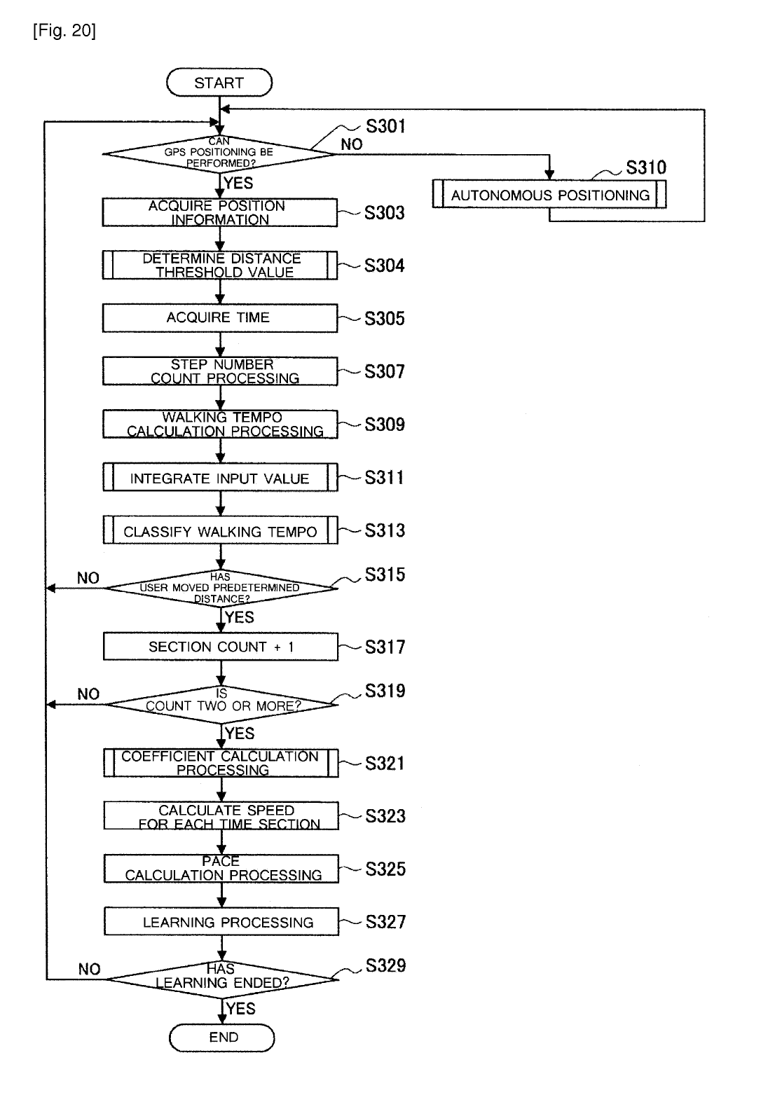

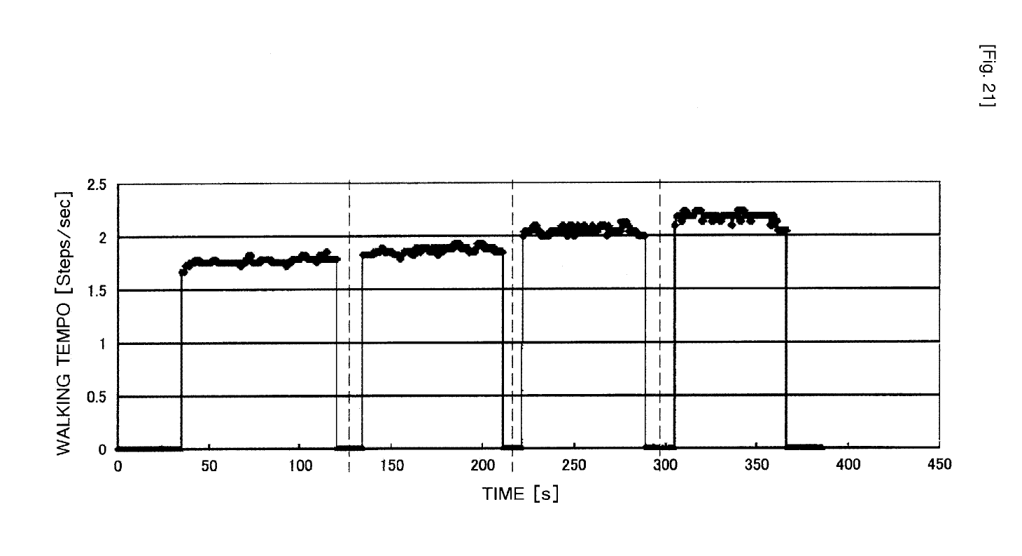

Next, an operation of the portable terminal according to the third embodiment of the present disclosure will be described with reference to FIG. 20. FIG. 20 is a flowchart of an example of an operation of the portable terminal according to the same embodiment.

First, the portable terminal 300 determines whether GPS positioning may be performed (S301). In this case, when it is determined that the GPS positioning may be performed, the absolute positioning unit 101 of the portable terminal 300 acquires position information at a current point of time (S303). The distance threshold value determining unit 109 determines the distance threshold value (S304). The distance threshold value determination processing in step S304 may be the distance threshold value determination processing described with reference to FIG. 4 or 5.

The counting unit 105 acquires time information at the current point of time (S305). The counting unit 105 counts time that passes from the current point of time and starts step number count processing (S307). The walking tempo calculating unit 107 calculates the walking tempo using the passed time and the number of steps counted by the counting unit 105 (S309).

The function specifying unit 310 integrates the input value (S311). Input value integration processing in step S311 may be the input value integration processing described above using FIG. 12. Next, the function specifying unit 310 executes the walking tempo classification processing (S313). The walking tempo classification processing may be the walking tempo classification processing described above using FIG. 14.

The function specifying unit 310 determines whether the user has moved the predetermined distance determined in step S304 (S315). In this case, when it is determined that the user has moved the predetermined distance, the function specifying unit 310 increases a section count by 1 (S317). Next, the function specifying unit 310 determines whether the section count is 2 or more (S319).

When it is determined that the section count is 2 or more in the determination of step S319, the function specifying unit 319 specifies the function by executing the coefficient calculation processing (S321). The coefficient calculation processing in step S321 may be the coefficient calculation processing described above using FIG. 13.

Next, the pace calculating unit 211 calculates the movement speed for each time section (S323). Next, the pace calculating unit 211 calculates the pace using the movement speed (S325). Next, the learning unit 113 learns a correspondence relation between the pace for each time section at which the movement speed is calculated and the walking tempo for each time section (S327). Next, the learning unit 113 determines whether learning has ended (S329). When it is determined that the learning has ended in step S329, the flow ends. Meanwhile, when it is determined that the learning has not ended in step S329, the process returns to step S301 and continues. When it is determined that the GPS positioning cannot be performed in step S301, the autonomous positioning unit 117 of the portable terminal 300 may perform the autonomous positioning (S310). The autonomous positioning that is performed in step S310 may be the processing of the autonomous positioning described above with reference to FIG. 6.

### 4-3. Experimental Result

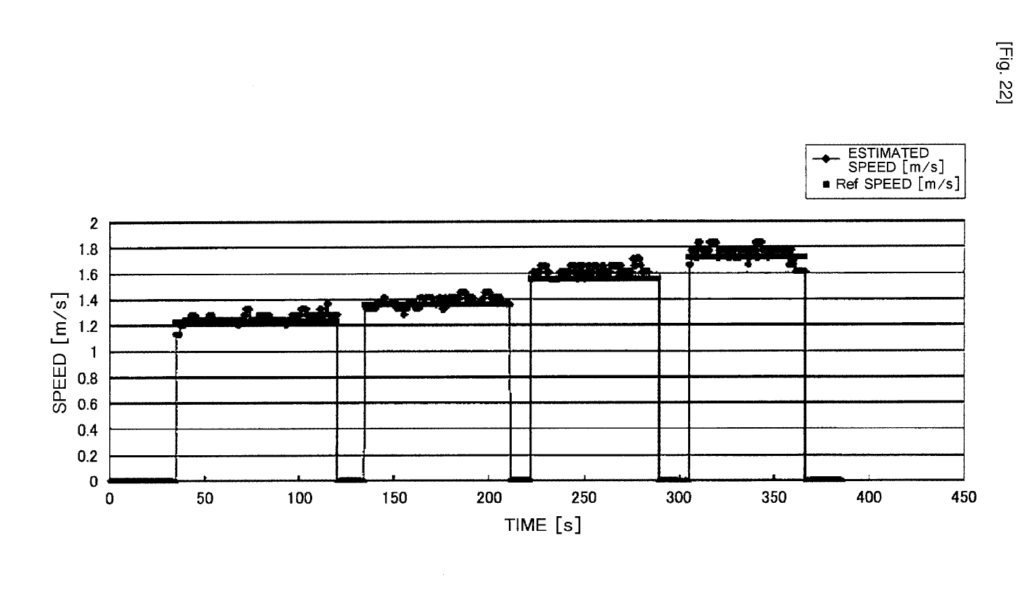

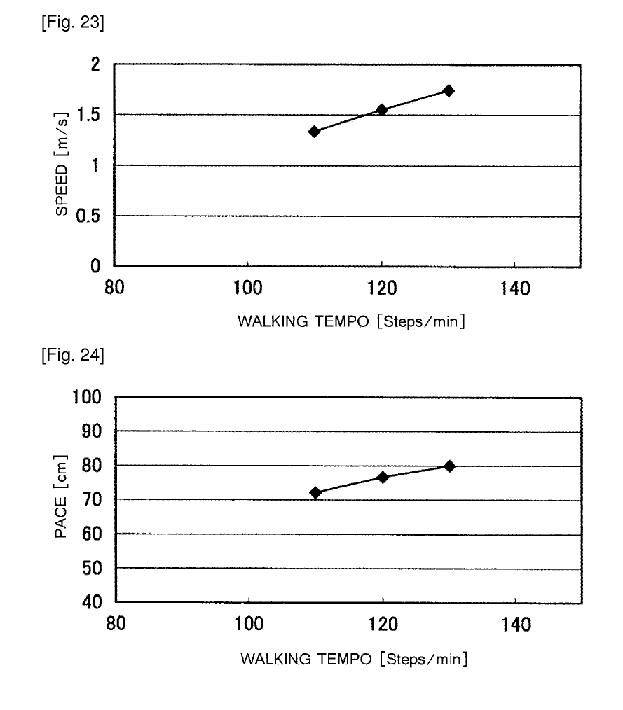

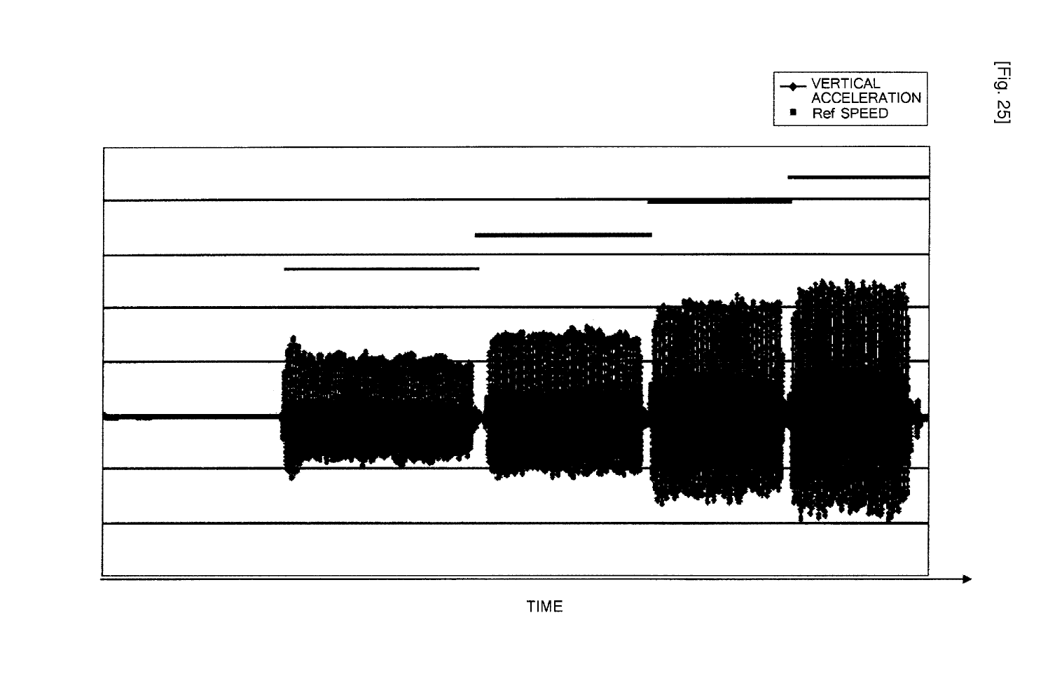

Next, experimental results verifying the validity of making correspondence tables of the portable terminal 300 according to this embodiment will be described with reference to FIGS. 21 to 24. FIG. 21 is a graph of an example of an experimental result showing a change of a walking tempo in the portable terminal according to the same embodiment. FIG. 22 is a graph of an example of an experimental result comparing a speed estimated in the portable terminal according to the same embodiment and an actual speed. FIG. 23 is an explanatory diagram illustrating an example of a correspondence table of a walking tempo and a speed that is made in the portable terminal according to the same embodiment. FIG. 24 is an explanatory diagram illustrating an example of a correspondence table of a walking tempo and a pace that is made in the portable terminal according to the same embodiment.

In this case, pace learning is performed by changing the speed in actuality and validity of a theory described in this embodiment is verified. FIG. 21 illustrates a change of the verified passed time and the measured walking tempo. In this case, at a point of time shown by a vertical broken line, the movement speed is changed. The speed gradually increases for each section.

As illustrated in FIG. 21, if peak values of the measured walking tempos are integrated and the known movement distance (400 m) is used, a coefficient a=1.25 and a coefficient b=−0.96 are calculated. The result of the calculation of the speed for each section that is performed based on the coefficients is illustrated in FIG. 22. FIG. 22 illustrates the estimated speed calculated from the specified function and the actual speed. As such, it is confirmed that the movement speed having high precision may be obtained.

In the example that is illustrated in FIGS. 21 and 22, the actually made correspondence table is illustrated in FIGS. 23 and 24. A vertical axis of FIG. 23 shows a speed and a vertical axis of FIG. 24 shows a pace. The speed and the pace may be calculated using the expression 1 (v=k′f).

### 4-4. Input Value

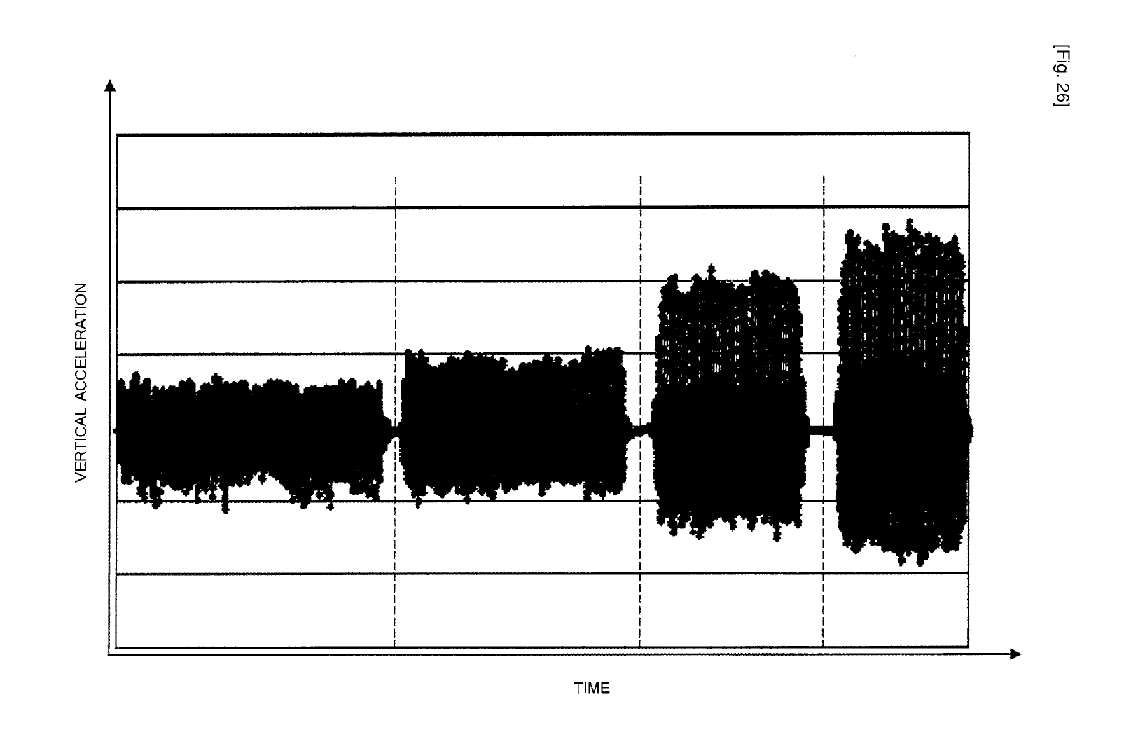

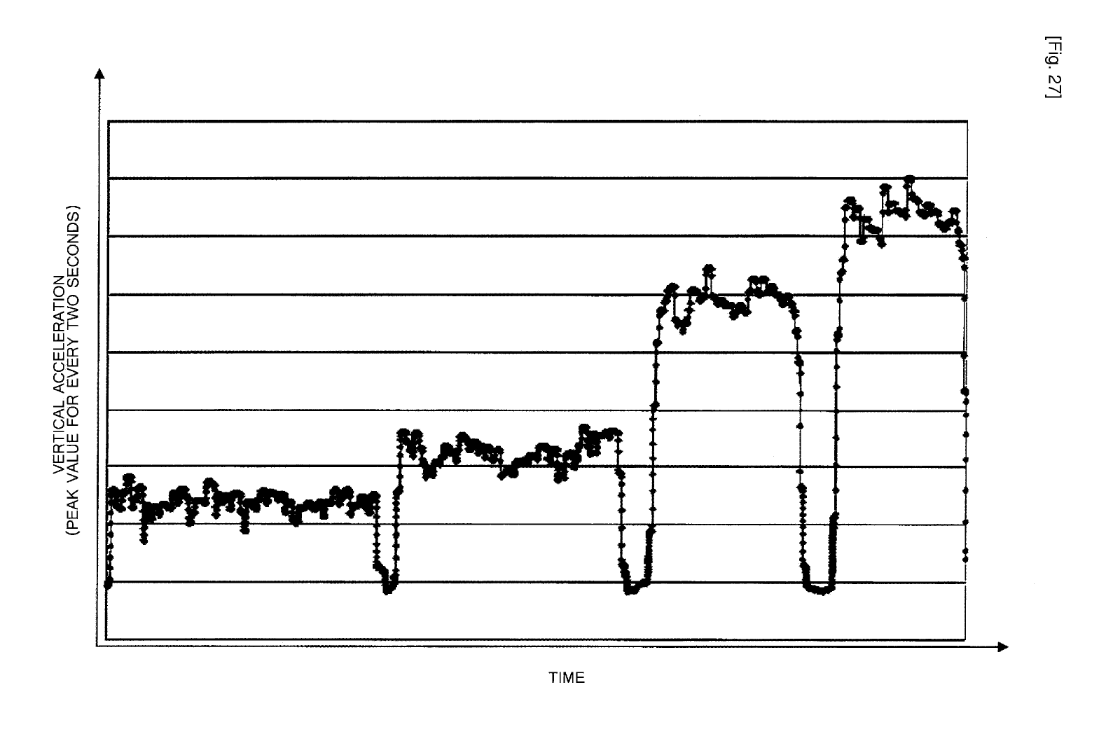

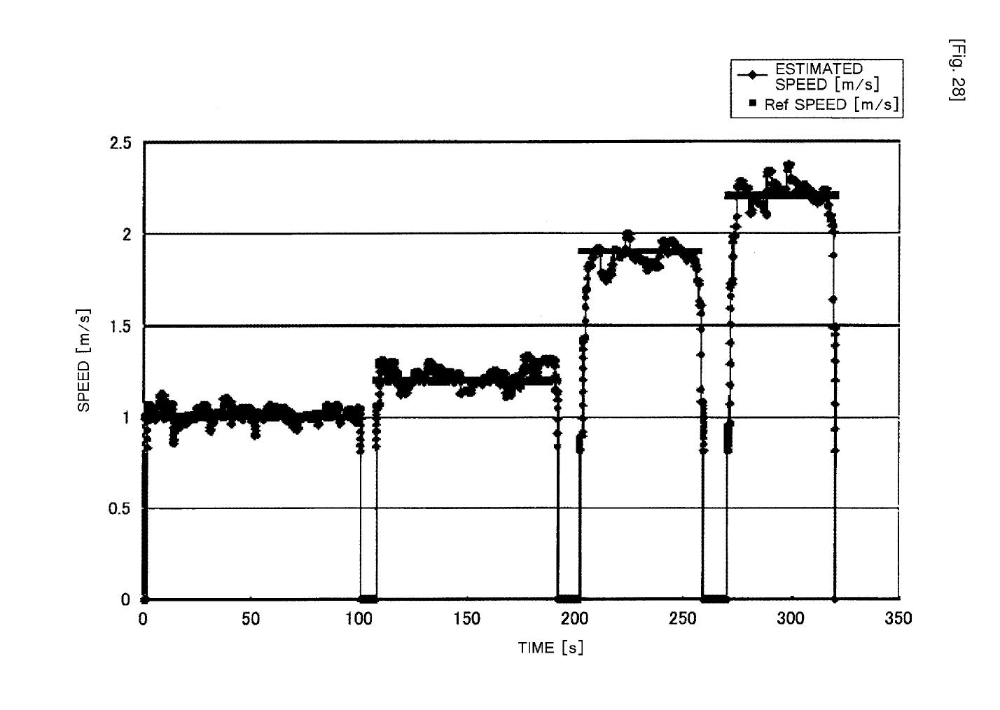

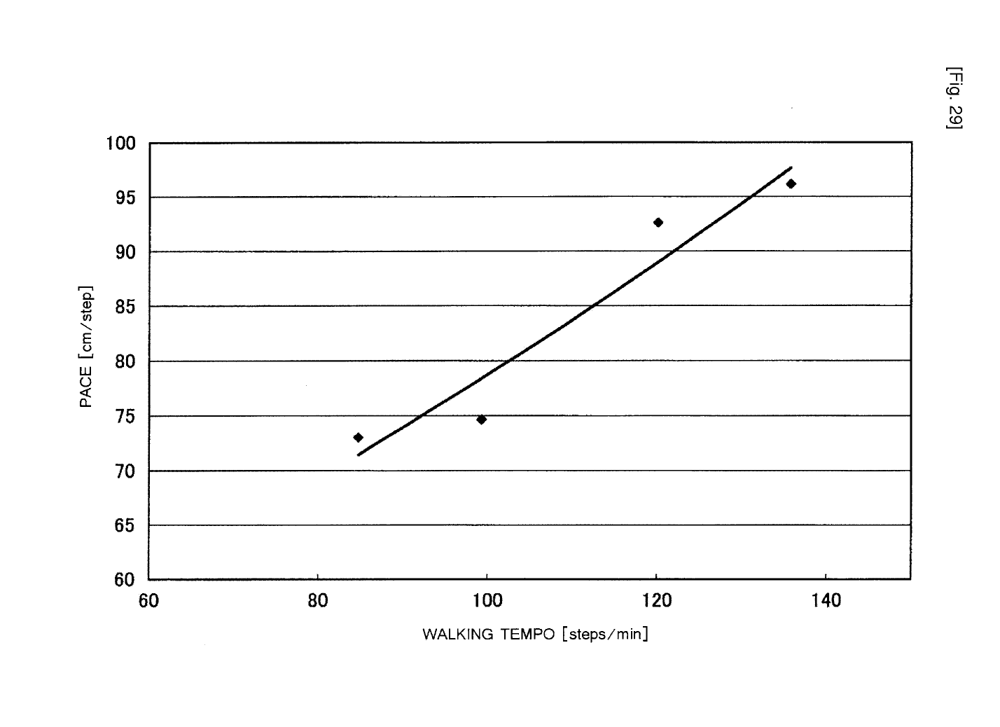

In the embodiment described above, the walking tempo f is used as the input value. However, if a correlation with the speed is strong and the correlation is a lower correlation, the input value is not limited to the walking tempo. In this case, another example of the input value will be described with reference to FIGS. 25 to 29. FIG. 25 is a graph of the case in which vertical acceleration measured in the portable terminal according to the same embodiment is correlated with an actual speed. FIG. 26 is a graph of an experimental result of vertical acceleration that was measured in a state in which the portable terminal according to the same embodiment was put into a front pants pocket. FIG. 27 is a graph of the case in which a peak value for every two seconds is extracted from the experimental result of FIG. 26. FIG. 28 is a graph of an experimental result comparing an estimated speed of each section calculated using the function specified in the portable terminal according to the same embodiment and an actual speed. FIG. 29 is an explanatory diagram illustrating an example of a correspondence table that is made using the function specified in the portable terminal according to the same embodiment.

For example, the vertical acceleration that is a value to be acquired in the currently spread portable terminal such as a general smart phone and one of an amount satisfying the condition may be used.

For example, referring to the experimental results illustrated in FIG. 25, it may be seen that the vertical acceleration and the speed have a clear correlation. Therefore, a function that is realized between the vertical acceleration and the speed is assumed and the function may be specified by calculating the coefficients. The speed is calculated from the coefficients, the walking tempo and the speed that are measured at the same time as the acceleration are associated, and the correspondence table is made.

For example, FIG. 26 illustrates a change of the vertical acceleration that was measured by the portable terminal 300 put into a front pants pocket. In FIG. 26, a vertical broken line shows times at which the speed changes. Among data illustrated in FIG. 26, the result of extraction of a peak value for two seconds is illustrated in FIG. 27. In this case, the extracted peak value is integrated and the known distance threshold value 400 m is used. As a result, the coefficient a=1.2 and the coefficient b=0.68 are calculated. If the movement speed for each section is calculated using the function specified by the calculated coefficients, the speed illustrated in FIG. 28 is obtained. FIG. 28 illustrates the actual speed and the speed calculated using the specified function. As such, it is confirmed that the movement speed having high precision is obtained using the vertical acceleration. A correspondence table that is made using the movement speed is illustrated in FIG. 29.

### 4-5. Method of carrying Portable Terminal

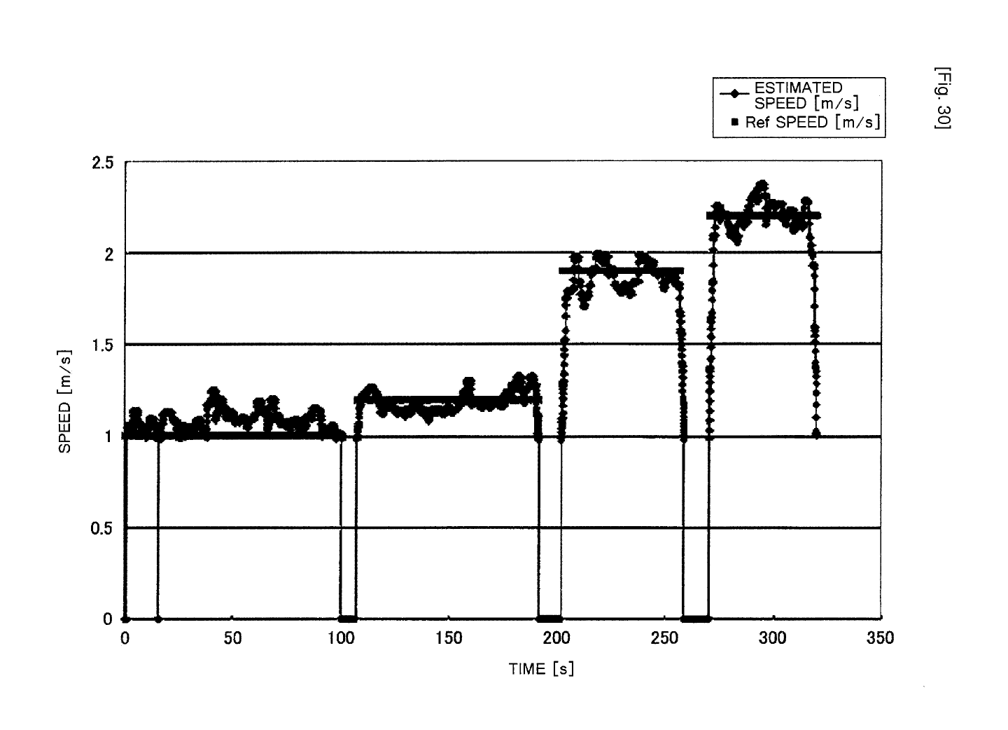

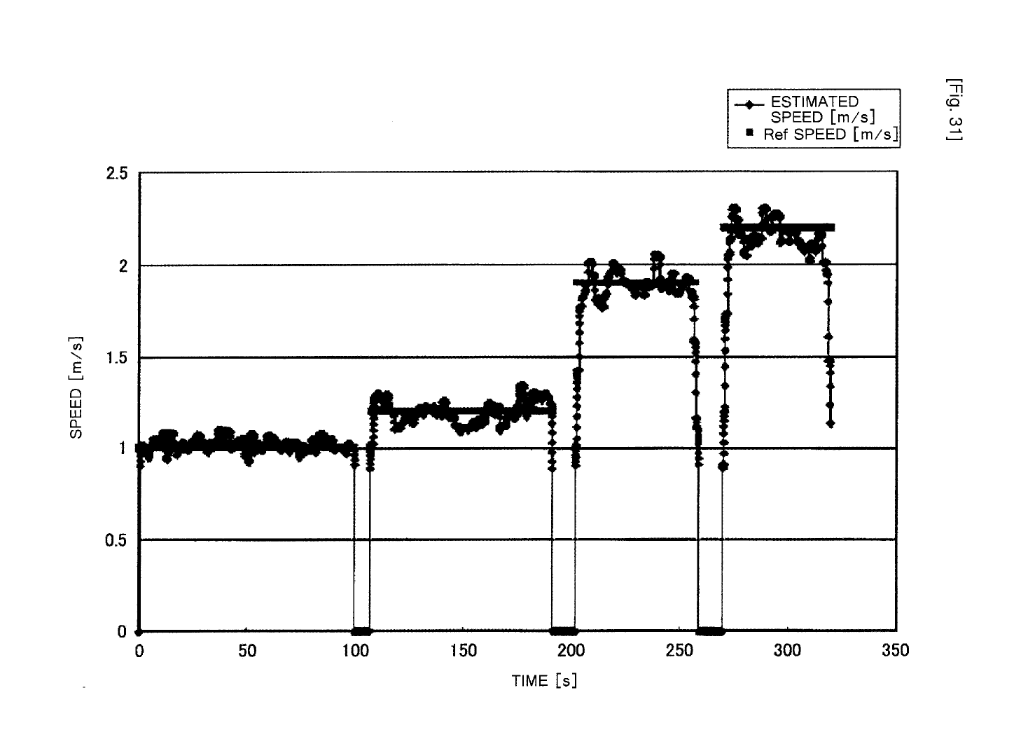

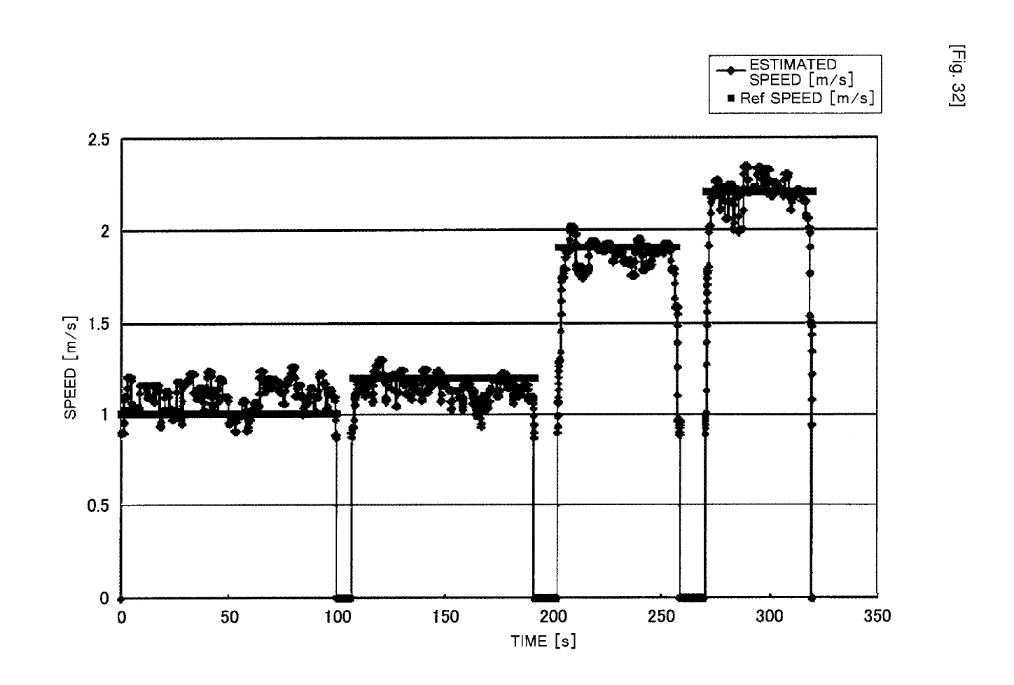

Next, dependency of a method of carrying the portable terminal 300 will be verified with reference to FIGS. 30 to 33. FIG. 30 is a graph of an experimental result comparing an estimated speed for each section calculated using the function specified by the vertical acceleration measured in a state in which the portable terminal according to the same embodiment was put into a breast pocket and an actual speed. FIG. 31 is a graph of an experimental result comparing an estimated speed for each section calculated using the function specified by the vertical acceleration measured in a state in which the portable terminal according to the same embodiment was put into a stomach pocket and an actual speed. FIG. 32 is a graph of an experimental result comparing an estimated speed for each section calculated using the function specified by the vertical acceleration measured in a state in which the portable terminal according to the same embodiment was put into a back pants pocket and an actual speed. FIG. 33 is a graph of an experimental result comparing an estimated speed for each section calculated using the function specified by the vertical acceleration measured in a state in which the portable terminal according to the same embodiment was put into an oblique bag and an actual speed.

The example of the case in which the walking tempo and the vertical acceleration are used as the input values has been described. The input value needs to have a strong correlation with the speed, depending on how the user carries the portable terminal 300. As the method of carrying the portable terminal 300, a method of putting the portable terminal into a breast pocket and carrying the portable terminal, a method of putting the portable terminal into a stomach pocket and carrying the portable terminal, a method of putting the portable terminal into a back pants pocket and carrying the portable terminal, and a method of putting the portable terminal into a bag and carrying the portable terminal are generally used. In addition, the portable terminal may be mounted on a head, the portable terminal may be mounted on an upper arm, the portable terminal may be mounted in a form of a wrist watch, the portable terminal may be mounted in a form of a neck strap, the user may view a screen while carrying the portable terminal with hands, or the portable terminal may be put into a front pants pocket.

In FIGS. 30 to 33, dependency of the vertical acceleration with respect to the method of carrying the portable terminal is verified. For example, FIG. 30 illustrates the estimated speed calculated using the vertical acceleration detected when the user walks with the portable terminal 300 put into the breast pocket as the input value and the actual speed. FIG. 31 illustrates the estimated speed calculated using the vertical acceleration detected when the user walks with the portable terminal 300 put into the stomach pocket as the input value and the actual speed. FIG. 32 illustrates the estimated speed calculated using the vertical acceleration detected when the user walks with the portable terminal 300 put into the back pants pocket as the input value and the actual speed. FIG. 33 illustrates the estimated speed calculated using the vertical acceleration detected when the user walks with the portable terminal 300 put into the oblique bag as the input value and the actual speed.

As described above, in the case of the vertical acceleration, the primary correlation with the speed is maintained without depending on the method of carrying the portable terminal. Therefore, even when the vertical acceleration is used as the input value, the speed having high precision is obtained, similar to the walking tempo, and the pace having high precision is calculated.

The preferred embodiments of the present disclosure have been described in detail above with reference to the accompanying drawings, whilst the present disclosure is not limited to the above examples, of course. A person skilled in the art may find various alterations and modifications within the scope of the appended claims, and it should be understood that they will naturally come under the technical scope of the present disclosure.

For example, in the embodiments, the GPS is used as the example of the positioning satellite. However, the positioning satellite is not limited to the GPS. As the positioning satellite, various positioning satellites such as Galileo, GLONASS, Compass, and QZSS may be used. At this time, as the positioning satellite, one kind of satellite may be used or a plurality of kinds of satellites may be used and positioning signals may be combined. The configuration that is used to acquire the position information may be appropriately changed according to a technical level when the embodiment is carried out.

In the present specification, the steps that are described in the flowchart include the processes that are executed temporally according to the described order and the processes that are not necessarily executed temporally but are executed in parallel or individually. The order may be appropriately changed in the steps processed temporally, if necessary.

The following configuration is included in the technical scope of the present disclosure.

(1)

An information processing apparatus including:

an absolute position acquiring unit that acquires an absolute position of a user;

an acquiring unit that acquires first values according to physical movement of the user who walks;

a function specifying unit that assumes a function showing a relation between the first values and second values showing a pace or a walking speed of the user, calculates coefficients included in the function based on the first values and the absolute position, and specifies the function;

a calculating unit that calculates the second values corresponding to the first values using the function; and

a learning unit that learns a correspondence relation between a walking tempo of the user and the second values using the calculated second values.

(2)

The information processing apparatus according to (1),

wherein the function specifying unit calculates an integration value of the first values and a movement time of the user corresponding to the integration value and calculates the coefficients based on the integration value, the movement time, and a movement distance.

(3)

The information processing apparatus according to (2), further including:

a walking determining unit that determines whether the user is walking, wherein the function specifying unit measures a time during which it is determined that the user is walking and calculates the movement time.

(4)

The information processing apparatus according to any one of (1) to (3),

wherein the function specifying unit classifies the first values into classes of predetermined widths, and

the calculating unit calculates an average of the first values for each class and calculates the second value corresponding to the average of the first values.

(5)

The information processing apparatus according to any one of (1) to (4), further including:

a direction acquiring unit that acquires a direction in which the user moves; and

an autonomous positioning unit that estimates the second value at a current point of time from the first values acquired by the acquiring unit using the correspondence relation learned by the learning unit, and calculates a current position based on the second value and the direction.

(6)

The information processing apparatus according to (5),

wherein the autonomous positioning unit calculates the current position when the absolute position acquiring unit does not acquire the absolute position.

(7)

The information processing apparatus according to (5) or (6), further including:

a navigation unit that guides a path using the current position calculated by the autonomous positioning unit.

(8)

The information processing apparatus according to any one of (1) to (7),

wherein the first value is a value that shows the walking tempo.

(9)

The information processing apparatus according to any one of (1) to (7),

wherein the first value is a value that shows vertical acceleration.

(10)

An information processing method including:

acquiring an absolute position of a user;

acquiring first values according to physical movement of the user who walks;

assuming a function showing a relation between the first values and second values showing a pace or a walking speed of the user, calculating coefficients included in the function based on the first values and the absolute position, and specifying the function;

calculating the second values corresponding to the first values using the function; and

learning a correspondence relation between a walking tempo of the user and the second values using the calculated second values.

(11)

A program for causing a computer to function as an information processing apparatus, wherein the information processing apparatus includes:

an absolute position acquiring unit that acquires an absolute position of a user;

an acquiring unit that acquires first values according to physical movement of the user who walks;

a function specifying unit that assumes a function showing a relation between the first values and second values showing a pace or a walking speed of the user, calculates coefficients included in the function based on the first values and the absolute position, and specifies the function;

a calculating unit that calculates the second values corresponding to the first values using the function; and

a learning unit that learns a correspondence relation between a walking tempo of the user and the second values using the calculated second values.

(12)

A computer readable recording medium that stores a program for causing a computer to function as an information processing apparatus,

wherein the information processing apparatus includes:

an absolute position acquiring unit that acquires an absolute position of a user;

an acquiring unit that acquires first values according to physical movement of the user who walks;

a function specifying unit that assumes a function showing a relation between the first values and second values showing a pace or a walking speed of the user, calculates coefficients included in the function based on the first values and the absolute position, and specifies the function;

a calculating unit that calculates the second values corresponding to the first values using the function; and

a learning unit that learns a correspondence relation between a walking tempo of the user and the second values using the calculated second values.

### REFERENCE SIGNS LIST

100, 200, 300 Portable terminal
101 Absolute positioning unit
103 Walking determining unit
105 Counting unit
107 Walking tempo calculating unit
109 Distance threshold value determining unit
111, 211 Pace calculating unit
113 Learning unit
115 Direction acquiring unit
117 Autonomous positioning unit
119 Navigation unit
121 Map information storage unit
123 Correspondence table storage unit
210, 310 Function specifying unit

1. An information processing apparatus comprising:
an absolute position acquiring unit that acquires an absolute position of a user;
an acquiring unit that acquires first values according to physical movement of the user who walks;
a function specifying unit that assumes a function showing a relation between the first values and second values showing a pace or a walking speed of the user, calculates coefficients included in the function based on the first values and the absolute position, and specifies the function;
a calculating unit that calculates the second values corresponding to the first values using the function; and
a learning unit that learns a correspondence relation between a walking tempo of the user and the second values using the calculated second values.

2. The information processing apparatus according to claim 1,
wherein the function specifying unit calculates an integration value of the first values and a movement time of the user corresponding to the integration value and calculates the coefficients based on the integration value, the movement time, and a movement distance.

3. The information processing apparatus according to claim 2, further comprising:
a walking determining unit that determines whether the user is walking, wherein the function specifying unit measures a time during which it is determined that the user is walking and calculates the movement time.

4. The information processing apparatus according to claim 1,
wherein the function specifying unit classifies the first values into classes of predetermined widths, and
the calculating unit calculates an average of the first values for each class and calculates the second value corresponding to the average of the first values.

5. The information processing apparatus according to claim 1, further comprising:
a direction acquiring unit that acquires a direction in which the user moves; and
an autonomous positioning unit that estimates the second value at a current point of time from the first values acquired by the acquiring unit using the correspondence relation learned by the learning unit, and calculates a current position based on the second value and the direction.

6. The information processing apparatus according to claim 5,
wherein the autonomous positioning unit calculates the current position when the absolute position acquiring unit does not acquire the absolute position.

7. The information processing apparatus according to claim 5, further comprising:
a navigation unit that guides a path using the current position calculated by the autonomous positioning unit.

8. The information processing apparatus according to claim 1,
wherein the first value is a value that shows the walking tempo.

9. The information processing apparatus according to claim 1,
wherein the first value is a value that shows vertical acceleration.

10. An information processing method comprising:
acquiring an absolute position of a user;
acquiring first values according to physical movement of the user who walks;
assuming a function showing a relation between the first values and second values showing a pace or a walking speed of the user, calculating coefficients included in the function based on the first values and the absolute position, and specifying the function;
calculating the second values corresponding to the first values using the function; and
learning a correspondence relation between a walking tempo of the user and the second values using the calculated second values.

11. A program for causing a computer to function as an information processing apparatus,
wherein the information processing apparatus includes:
an absolute position acquiring unit that acquires an absolute position of a user;
an acquiring unit that acquires first values according to physical movement of the user who walks;
a function specifying unit that assumes a function showing a relation between the first values and second values showing a pace or a walking speed of the user, calculates coefficients included in the function based on the first values and the absolute position, and specifies the function;
a calculating unit that calculates the second values corresponding to the first values using the function; and
a learning unit that learns a correspondence relation between a walking tempo of the user and the second values using the calculated second values.

12. A computer readable recording medium that stores a program for causing a computer to function as an information processing apparatus, wherein the information processing apparatus includes:
an absolute position acquiring unit that acquires an absolute position of a user;
an acquiring unit that acquires first values according to physical movement of the user who walks;
a function specifying unit that assumes a function showing a relation between the first values and second values showing a pace or a walking speed of the user, calculates coefficients included in the function based on the first values and the absolute position, and specifies the function;
a calculating unit that calculates the second values corresponding to the first values using the function; and
a learning unit that learns a correspondence relation between a walking tempo of the user and the second values using the calculated second values.
